(19) United States
(12) Patent Application Publication
(10) Pub. No.: US 2018/0137119 A1
(43) Pub. Date: May 17, 2018

(54) IMAGE MANAGEMENT METHOD AND APPARATUS THEREOF

(71) Applicant: Samsung Electronics Co., Ltd., Suwon-si (KR)

(72) Inventors: Zhixuan LI, Beijing (CN); Li ZUO, Beijing (CN); Zijian XU, Beijing (CN); Wei ZHENG, Beijing (CN); Jili GU, Beijing (CN); Jinbin LIN, Beijing (CN); Junjun XIONG, Beijing (CN)

(21) Appl. No.: 15/814,972

(22) Filed: Nov. 16, 2017

(30) Foreign Application Priority Data
Nov. 16, 2016 (CN) 201611007300.8
Nov. 8, 2017 (KR) 10-2017-0148051

(51) Int. Cl. G06F 17/30; H04N 5/232

(52) U.S. Cl. CPC G06F 17/3028; H04N 5/23293; G06F 17/30274; G06F 17/30268

(57) ABSTRACT

An image management method and an apparatus therefor are provided. The image management method includes detecting an operation of a user on an image, and performing image management according to the operation and a region of interest (ROI) in the image. The solution provided by the embodiments of the present disclosure performs image management based on ROI of the user, and thus can meet a user's requirement and improve image management efficiency.

### CROSS-REFERENCE TO RELATED APPLICATION(S)

This application claims the benefit under 35 U.S.C. § 119(a) of a Chinese patent application filed on Nov. 16, 2016 in the State Intellectual Property Office of the People's Republic of China and assigned Serial number 201611007300.8, and of a Korean patent application filed on Nov. 8, 2017 in the Korean Intellectual Property Office and assigned Serial number 10-2017-0148051, the entire disclosure of each of which is hereby incorporated by reference.

### TECHNICAL FIELD

The present disclosure relates to image processing technologies. More particularly, the present disclosure relates to an image management method and an apparatus thereof.

### BACKGROUND

With the improvement of intelligent device hardware production capabilities and decreases in related cost, there is a large impetus in increasing camera performance and storage capacity. Thus, intelligent devices may store a large number (amount) of images. Users may have more and more requirements for browsing and searching, sharing and managing the images.

In conventional techniques, the images are mainly browsed according to a time dimension. In the browsing interface, when the user switches images, all images are shown to the user according to a time order, according to the related art.

However, the image browsing based on the time dimension ignores the interest(s) of the user.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an image management method and an apparatus thereof. The technical solution of the present disclosure includes the following.

In accordance with an aspect of the present disclosure, an image management method is provided. The image management method includes detecting an operation of a user on an image, and performing image management according to the operation and a region of interest (ROI) in the image.

In accordance with another aspect of the present disclosure, an image management apparatus is provided. The image management apparatus includes a memory, and at least one processor configured to detect an operation of a user on an image, and perform image management according to the operation and an ROI in the image.

According to the embodiments of the present disclosure, an operation of the user on the image is detected firstly, and then image management is performed based on the operation and the ROI of the image. In view of the above, embodiments of the present disclosure perform image management according to the interest of the user, thus is able to meet user's requirement and improve image management efficiency.

Other aspects, advantages, and salient features of the disclosure will become apparent to those skilled in the art from the following detailed description, which, taken in conjunction with the annexed drawings, discloses various embodiments of the pre sent disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating an image management method according to various embodiments of the present disclosure;

FIG. 2A is a flowchart of obtaining an image attribute list according to various embodiments of the present disclosure;

FIG. 2B is a schematic diagram illustrating a region list of an image according to various embodiments of the present disclosure;

FIG. 3 is a schematic diagram illustrating a process of determining a region of interest (ROI) based on manual focusing according to various embodiments of the present disclosure;

FIG. 4 is a schematic diagram illustrating a process of determining a ROI based on a gaze heat map and/or a saliency map according to various embodiments of the present disclosure;

FIGS. 5A, 5B, 5C, and 5D show determination of a ROI based on the saliency map according to various embodiments of the present disclosure;

FIG. 6A is a schematic diagram illustrating an object detection with category label according to embodiments of the present disclosure;

FIG. 6B is a schematic diagram illustrating generation of category label based on an object classifier according to various embodiments of the present disclosure;

FIG. 6C is a schematic diagram illustrating a combination of heat map detection and image classification according to various embodiments of the present disclosure;

FIG. 7 is a flowchart illustrating a quick browsing during image browsing according to various embodiments of the present disclosure;

FIG. 8 is a flowchart illustrating implementation of personalized tree hierarchy according to various embodiments of the present disclosure;

FIG. 9 is a flowchart illustrating implementation of classification based on the personalized category according to various embodiments of the present disclosure;

FIG. 10 is a flowchart illustrating selection of different transmission modes according to various embodiments of the present disclosure;

FIG. 11 is a flowchart of actively sharing an image by a user according to various embodiments of the present disclosure;

FIGS. 12A and 12B are flowcharts of image sharing when the user uses a social application according to various embodiments of the present disclosure;

FIGS. 13A, 13B, 13C, 13D, 13E, 13F, and 13G show quick browsing in an image browsing interface according to various embodiments of the present disclosure;

FIGS. 14A, 14B, and 14C show quick view based on multiple images according to various embodiments of the present disclosure;

FIGS. 15A, 15B, and 15C show quick view in a video according to various embodiments of the present disclosure;

FIG. 16 is a schematic diagram of quick view in a camera preview mode according to various embodiments of the present disclosure;

FIG. 17 is a schematic diagram of a first structure of a personalized tree hierarchy according to various embodiments of the present disclosure;

FIG. 18 is a schematic diagram of a second structure of a tree hierarchy according to various embodiments of the present disclosure;

FIG. 19 is a schematic diagram illustrating a quick view of the tree hierarchy by a mobile device according to various embodiments of the present disclosure;

FIG. 20 is a flowchart illustrating quick view of the tree hierarchy by a small screen device according to various embodiments of the present disclosure;

FIGS. 21A and 21B are schematic diagrams illustrating quick view of the tree hierarchy on a small screen device according to various embodiments of the present disclosure;

FIG. 22 shows displaying of images by a small screen device according to various embodiments of the present disclosure;

FIG. 23 shows transmission modes under different transmission amounts according to various embodiments of the present disclosure;

FIG. 24 shows transmission modes under different network transmission situations according to various embodiments of the present disclosure;

FIG. 25 is a first schematic diagram illustrating image sharing in thumbnail view mode according to various embodiments of the present disclosure;

FIGS. 26A, 26B, and 26C are second schematic diagrams illustrating image sharing in the thumbnail view mode according to various embodiments of the present disclosure;

FIG. 27 shows a first sharing manner in a chat interface according to various embodiments of the present disclosure;

FIG. 28 shows a second sharing manner in the chat interface according to various embodiments of the present disclosure;

FIG. 29 is a schematic diagram illustrating an image selection method from image to text according to various embodiments of the present disclosure;

FIG. 30 is a schematic diagram illustrating an image selection method from text to image according to various embodiments of the present disclosure;

FIG. 31 is a schematic diagram illustrating image conversion based on image content according to various embodiments of the present disclosure;

FIG. 32 is a schematic diagram illustrating intelligent deletion based on image content according to various embodiments of the present disclosure;

FIG. 33 is a schematic diagram illustrating a structure of an image management apparatus according to various embodiments of the present disclosure; and

FIG. 34 is a schematic block diagram illustrating a configuration example of a processor included in an image management apparatus according to various embodiments of the present disclosure.

Throughout the drawings, like reference numerals will be understood to refer to like parts, components, and structures.

### DETAILED DESCRIPTION

The following description with reference to accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various embodiments of the present disclosure provide a content-based image management method, mainly including performing image management based on region of interest (ROI) of a user, e.g., quick browsing, searching, adaptive transmission, personalized file organization, quick sharing and deleting, etc.

The embodiments provided by the present disclosure may be applied in an album management application of an intelligent device, or applied in an album management application at a cloud end, etc.

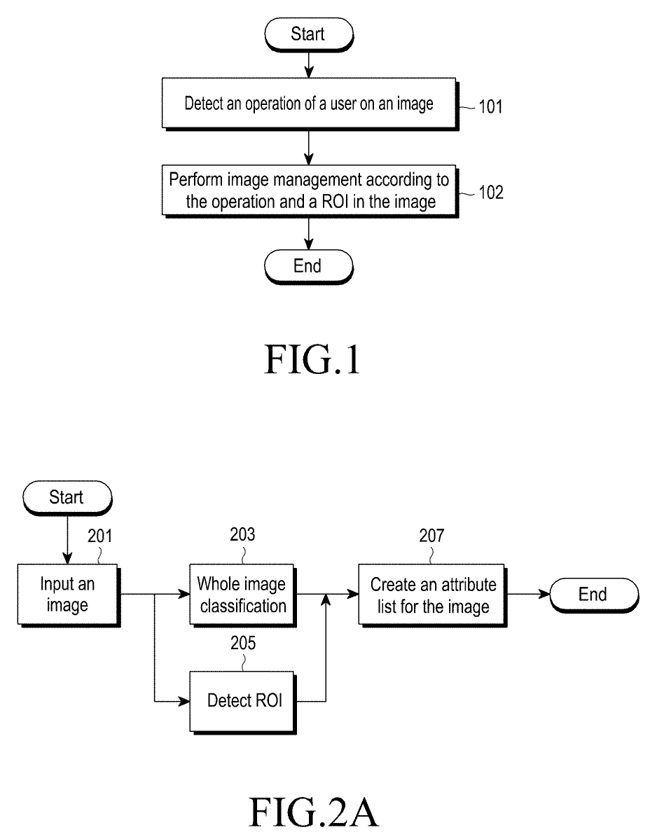

FIG. 1 is a flowchart illustrating an image management method according to various embodiments of the present disclosure.

Referring to FIG. 1, the method includes the following.

At operation 101, a user's operation with respect to an image is detected.

At operation 102, image management is performed according to the operation and a region of interest (ROI) of the user in the image.

The ROI of the user may be a region with specific meaning in the image.

In embodiments, the ROI of the user may be determined in operation 102 via at least one of the following manners.

In manner (1), a manual focus point during photo shooting is detected, and an image region corresponding to the manual focus point is determined as the ROI of the user.

During the photo shooting process, the region corresponding to the manual focus point has a high probability to be the region that the user is interested in. Therefore, it is possible to determine the image region corresponding to the manual focus point as the ROI of the user.

In manner (2), an auto-focus point during photo shooting is detected, and an image region corresponding to the auto-focus point is determined as the ROI of the user.

During the photo shooting process, the region which is automatically focused by a camera may also be the ROI of the user. Therefore, it is possible to determine the image region corresponding to the auto-focus point as the ROI of the user.

In manner (3), an object region in the image is detected, and the object region is determined as the ROI of the user.

Herein, the object region may be human, animal, plant, vehicle, famous scenery, buildings, etc. Compared with other pixel regions in the image, the object region has a high probability to be the ROI of the user. Therefore, the object region may be determined as the ROI of the user.

In manner (4), a hot region in a gaze heat map in the image is detected, and the hot region in the gaze heat map is determined as the ROI of the user.

Herein, the hot region in the gaze heat map refers to a region that the user frequently gazes on when viewing images. The hot region in the gaze heat map may be the ROI of the user. Therefore, the hot region in the gaze heat map may be determined as the ROI of the user.

In manner (5), a hot region in a saliency map in the image is detected, and the hot region in the saliency map is determined as the ROI of the user.

Herein, the hot region in the saliency map refers to a region having significant visual difference with other regions, and a viewer tends to have interest in that region. The hot region in the saliency map may be determined as the ROI of the user.

In embodiments, a set of ROIs may be determined according to manners such as manual focusing, auto-focusing, gaze heat map, object detection, saliency map detection, etc. Then, according to a predefined sorting factor, the ROIs in the set are sorted. One or more ROIs are finally determined according to a sorted result. In embodiments, the predefined sorting factor may include: source priority, position priority, category label priority; classification confidence score priority, view frequency priority, etc.

In embodiments, when images are subsequently displayed to the user, the sorted result of the ROIs in the images may affect the priorities of the corresponding images. For example, an image containing a ROI ranked on top may have a relatively higher priority and thus may be shown to the user preferably.

The above describes various manners for determining the ROI of the user in the image. Those with ordinary skill in the art should know that these embodiments are merely some examples and are not used for restricting the protection scope of the present disclosure.

In embodiments, the method may further include generating a category label for the ROI of the user. The category label is used for indicating the category that the ROI of the user belongs to. In embodiments, it is possible to generate the category label based on the object region detecting result during the detection of the object in the image. Alternatively, it is possible to input the ROI of the user into an object classifier and generate the category label according to an output result of the object classifier.

In embodiments of the present disclosure, after determining the ROI of the user, the method may further include: generating a region list for the image, the region list includes a region field corresponding to the ROI of the user, and the region field includes the category label of the ROI of the user. There may be one or more ROIs in the image. Therefore, there may be one or more region fields in the region list. In embodiments, the region field may further include: source (e.g., the ROI is from which image); position (e.g. coordinate position of the ROI in the image); classification confidence score; browsing frequency, etc.

The above shows detailed information contained in the region field by some examples. Those with ordinary skill in the art should know that the above description merely shows some examples and is not used for restricting the protection scope of the present disclosure.

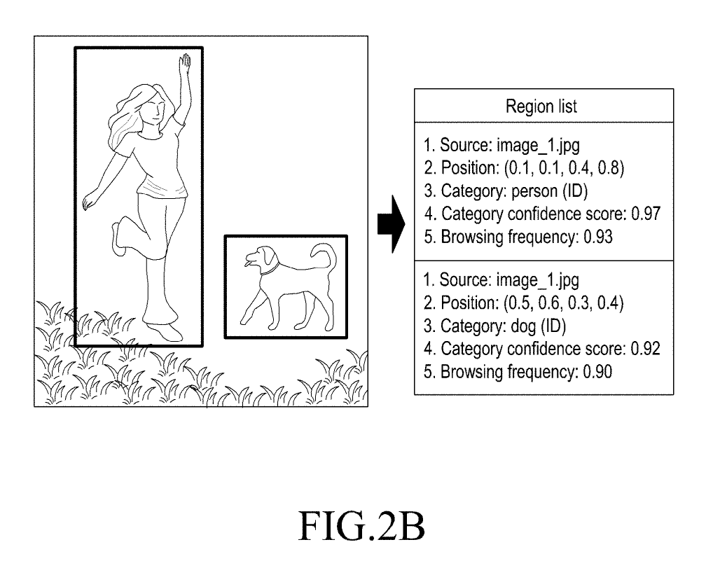

FIG. 2A is a flowchart illustrating a process of obtaining an image attribute list according to various embodiments of the present disclosure.

When creating the image attribute list, attribute information of the whole image as well as attribute information of each ROI should be considered. The attribute information of the whole image may include a classification result of the whole image, e.g., scene type.

Referring to FIG. 2A, the image is input at operation 201, the whole image is classified to obtain a classification result at operation 203. In addition, the ROI in the image needs to be detected at operation 205. This operation is mainly used for retrieving the ROI in the image. Through the two operations of whole image classification at operation 203 and ROI detection at operation 205, the image attribute list can be created at operation 207. The image attribute list includes the classification result of the whole image and the list of ROIs (hereinafter shortened as region list).

FIG. 2B is a schematic diagram showing a region list of an image according to embodiments of the present disclosure.

Referring to FIG. 2B, the image includes two ROIs, respectively a human region and a pet region. Correspondingly, the region list of the image includes two region fields respectively corresponding to the two ROIs. Each region field includes the following information of the ROI image source, position of the ROI in the image, category of the ROI (if the region contains human, identification (ID) of the person should be included), confidence score describing how confident that the ROI belongs to the category, and browsing frequency, etc.

Hereinafter, the procedure of determining the ROI of the user based on the manual focusing manner is described.

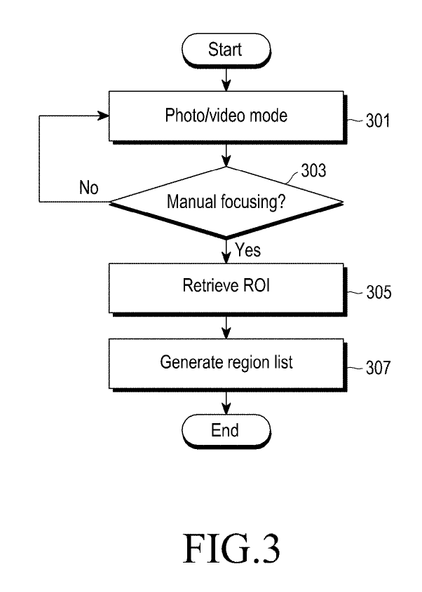

FIG. 3 is a schematic diagram illustrating the determination of the ROI of the user by manual focusing according to various embodiments of the present disclosure.

Referring to FIG. 3, if the device is in a photo mode or a video mode at operation 301, the device detects whether the user has a manual focusing action at operation 303. If detecting the manual focusing action of the user, the device records the manual focus point, crops a predetermined area corresponding to the manual focus point from the image, and determines the predetermined area as the ROI of the user at operations 305 and 307.

The predetermined area may be cropped from the image via the following manners:

(1) Cropping according to a predefined parameter. The parameter may include length-width ratio, proportion of the area to the total area of the image, fixed side length, etc.

(2) Automatic cropping according to image visual information. For example, the image may be segmented based on colors, and a segmented area having a color similar to that of the focus point may be cropped.

(3) Performing object detection in the image, determining the object region where the manual focus point belongs to, and determining the object region as the ROI and performing cropping of the object region.

Hereinafter, the procedure of determining the ROI of the user based on gaze heat map or saliency map is described.

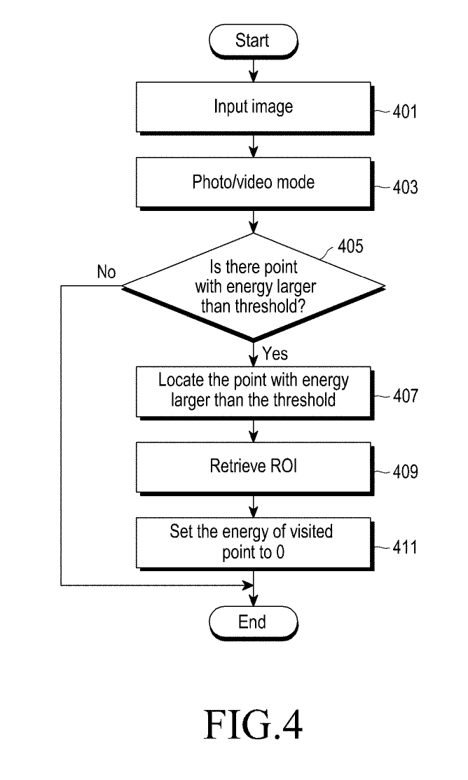

FIG. 4 is a schematic diagram illustrating determination of ROI of the user based on gaze heat map and/or saliency map according to embodiments of the present disclosure.

Referring to FIG. 4, an image is input at operation 401, and a gaze heat map and/or a saliency map are generated in turn at operation 403. Then, it is determined whether there is a point having a value higher than a predetermined threshold in the gaze heat map and/or the saliency map at operation 405. If there is, the point is taken as a starting point of a point set, and heat points adjacent to this point and having energies higher than the predetermined threshold are added to the point set, until there is no heat point having energy higher than the predetermined threshold around this point at operation 407, and a ROI is detected at operation 409. The energy values of the heat points are set to 0 at operation 411. The above procedure is repeated until there is no point with value higher than the predetermined threshold in the gaze heat map and/or the saliency map. Each point set forms a ROI of the user.

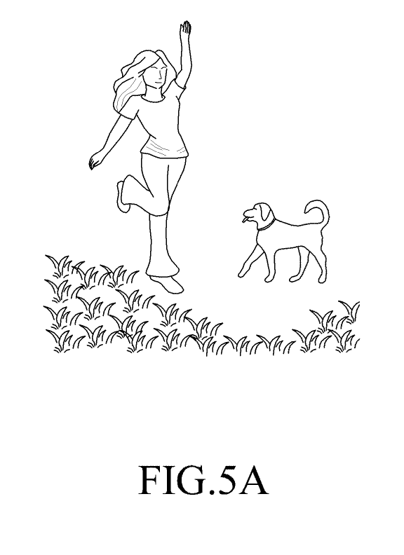

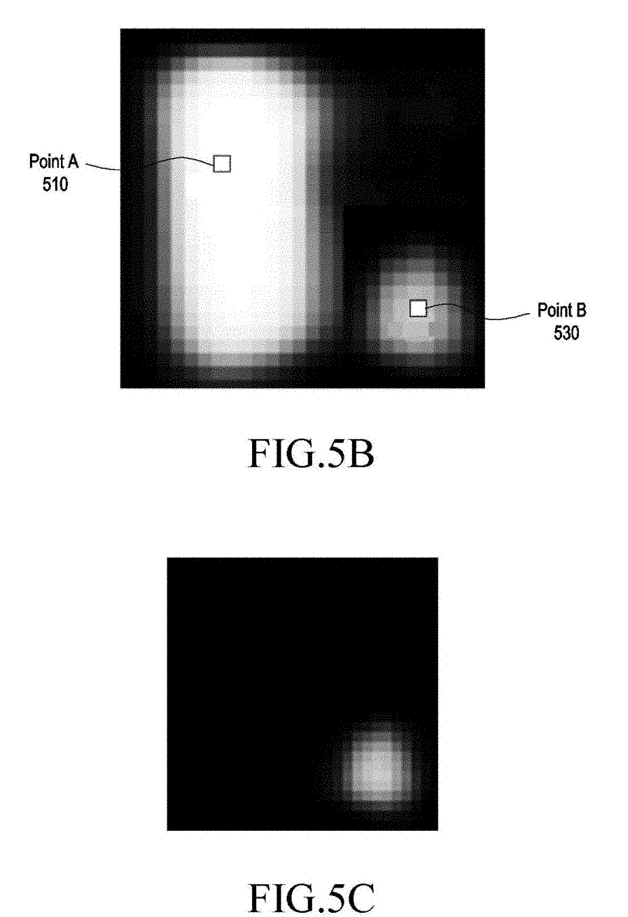

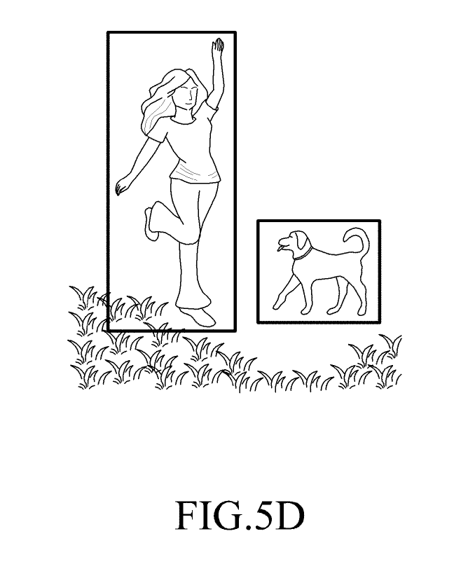

FIGS. 5A to 5C show the determination of the ROI of the user based on the saliency map according to various embodiments of the present disclosure.

FIG. 5A shows the input image.

FIG. 5B shows a saliency map corresponding to the input image.

Referring to FIG. 5B, the brighter each point represents the higher energy it has, and the darker the point represents the lower energy. When determining the ROI of the user, point A 510 in FIG. 5B is firstly selected as a starting point. From this point, bright points around this point are added to the point set with point A 510 as the starting point. The energies of these points are set to 0, as shown in FIG. 5C. Similarly, the above procedure is executed to retrieve a ROI starting from point B 530 in FIG. 5B. The finally determined ROIs of the user are as shown in FIG. 5D.

Hereinafter, the procedure of generating category label for the ROI of the user is described.

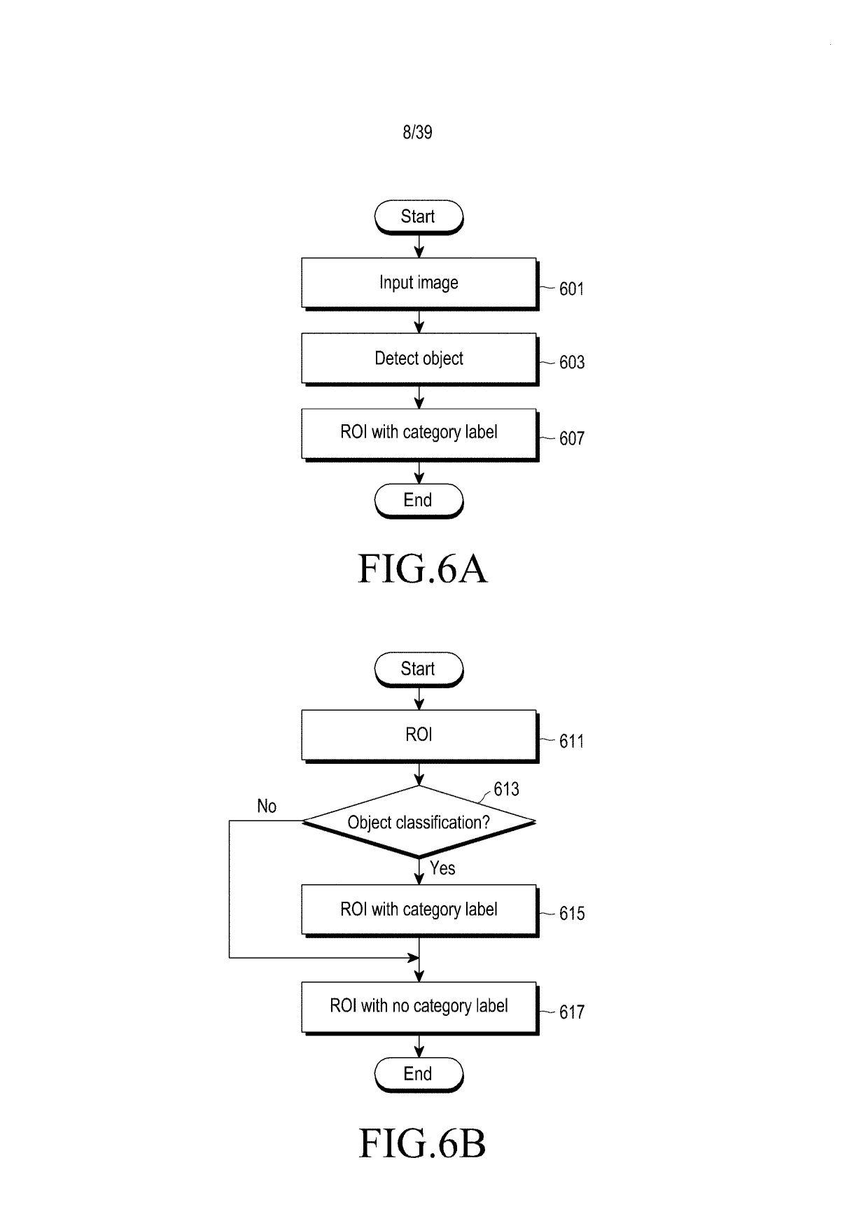

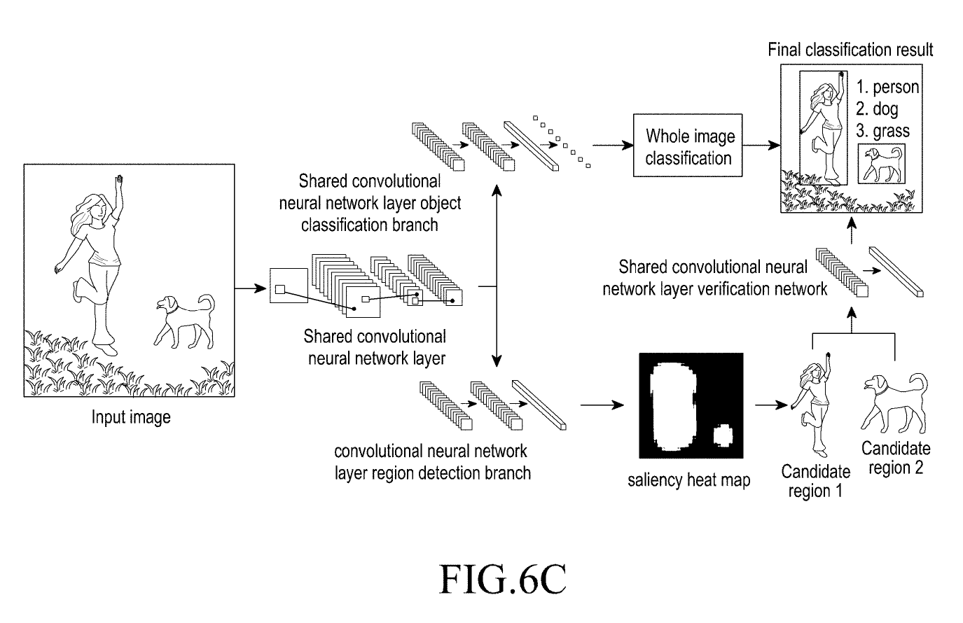

FIG. 6A is a schematic diagram illustrating generation of category label based on object detection according to embodiments of the present disclosure. In FIG. 6A, the flow of generating the region list including the category label of the object based on the object detection is shown.

Referring to FIG. 6A, an image is input first at operation 601. Then, object detection is performed to the input image at operation 603. The detected object is configured as the ROI of the user, and a category label is generated for the ROI of the user according to the category result of the object detection at operation 607.

FIG. 6B is a schematic diagram illustrating generation of category label based on object classifier according to various embodiments of the present disclosure.

Referring to FIG. 6B, the ROI of the user is input to an object classifier at operation 611. If the object classifier recognizes the category of the ROI of the user at operation 613, a category label is generated for the ROI of the user based on the category at operation 615, and a region list including the category label is generated at operation 617. If the object classifier cannot recognize the category of the ROI of the user, a region list without category label is generated.

In embodiments, the heat map detection (including gaze heat map and/or saliency map) and the image classification may be combined.

FIG. 6C is a schematic diagram illustrating a combination of the heat map detection and image classification according to various embodiments of the present disclosure.

Referring to FIGS. 6A to 6C, when the image is input, the image is processed by a shared convolutional neural network layer, a convolutional neural network object classification branch used for whole image classification and a convolutional neural network detection branch used for saliency detection, to obtain a classification result of the whole image and a saliency region detection result at the same time. Then, the detected saliency region is input to the convolutional neural verification network for object classification. Finally, the classification results are combined to obtain the final classification result of the image, and classified ROIs are obtained.

After the classified ROIs are obtained, the ROIs may be sorted based on, e.g., source of the ROI, confidence score that the ROI belongs to a particular category, browsing frequency of the ROI, etc. For example, the ROIs may be sorted according to a descending order of manual focusing, gaze heat map, object detection and saliency map detection. Finally, based on the sorted result, one or more ROIs of the user may be selected.

After determining the ROI of the image as described above, various kinds of applications may be implemented such as image browsing and searching, image organization structure, user album personalized category definition and accurate classification, image transmission, quick sharing, image selection and image deletion.

(1) On Aspect of Image Browsing and Searching.

In a practical application, a user may have different preferences and browsing frequencies for different images. If an image contains an object that the user is interested in, the image may be browsed for more times. Even if several images contain the object that the user is interested in, the browsing frequencies of them may be different due to various reasons. Therefore, user's personality needs to be considered when the candidate images are displayed. Further, it is necessary to provide a multi-image multi-object and multi-operation solution, so as to improve the experience of the user. In addition, various techniques do not consider how to display images on mobile devices with smaller screens (e.g., watch). If the image is simply scaled down, details of the image will be lost. In this case, it is necessary to obtain a region that the user is more interested in from the image and display the region on the small screen. In addition, in the case that there are a large number of images in the album, the user is able to browse the images quickly based on ROIs.

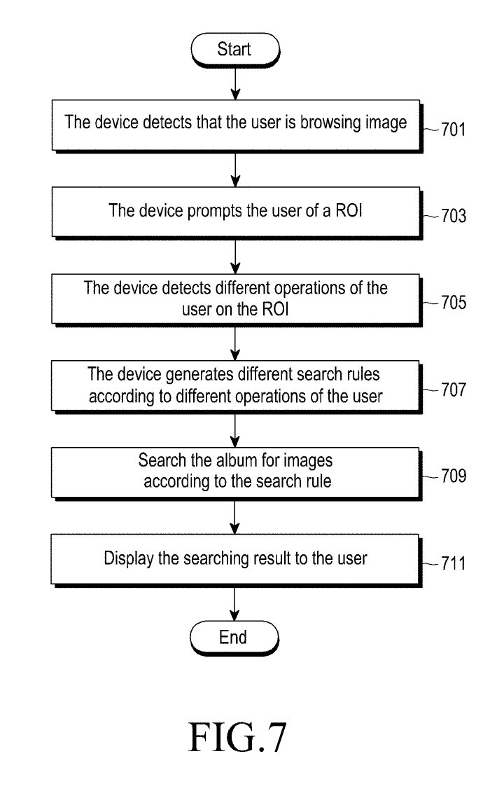

FIG. 7 is a flowchart illustrating quick browsing during image browsing according to various embodiments of the present disclosure.

Referring to FIG. 7, the device firstly detects that the user is browsing images in an album at operation 701. The device obtains the positions of the ROIs according to the ROI list, and prompts the user to interact with the ROIs at operation 703. When detecting an operation of the user on a ROI at operation 705, the device generates an image searching rule according to the operation of the user at operation 707, searches for images conforming to the searching rule in the album at operation 709 and displays the found images to the user at operation 711. In various embodiments, operation 101 (shown in FIG. 1) may include a selection operation selecting at least two ROIs, wherein the at least two ROIs belong to the same image or different images; and the operation of performing the image management in operation 102 (shown in FIG. 1) may be based on a selection operation selecting at least two images, providing corresponding images and/or video frames.

For example, an image searched out may include a ROI belonging to the same category with the at least two ROIs, or include a ROI belonging to the same category with one of the at least two ROIs, or does not include a ROI belonging to the same category with the at least two ROIs, or does not include a ROI belonging to the same category with one of the at least two ROIs, etc.

In particular, the searching rule may include at least one of the following:

(A), If the selection operation is a first type selection operation, the provided corresponding images and/or video frames include: a ROI corresponding to all ROIs on which the first type selection operation is performed. For example, the first type selection operation is used for determining those must be contained in the searching result.

For example, if the user desires to search for images containing both an airplane and a car, the user may find two images, wherein one contains an airplane and the other contains a car. The user respectively selects the airplane and the car in the two images, so as to determine the airplane and the car as the elements must be contained in the searching result. Then, a quick searching may be performed to obtain all images containing both airplane and car. Optionally, the user may also select the elements must be contained in the searching result from one image containing both an airplane and a car.

(B), If the selection operation is a second type selection operation, the provided corresponding images and/or video frames include: a ROI corresponding to at least one of the ROIs on which the second type selection operation is performed. For example, the second type selection operation is used for determining an element may be contained in the searching result.

For example, if the user desires to find images containing an airplane or a car, the user may find two images, wherein one contains an airplane and the other contains a car. The user selects the airplane and the car to configure the airplane and the car as the elements that may be contained in the searching result. Then, a quick searching may be performed to obtain all images containing an airplane or a car. Optionally, the user may also select the elements that may be contained in the searching result from one image containing both an airplane and a car.

(C), If the selection operation is a third type selection operation, the provided corresponding images and/or video frames do not include: a ROI corresponding to the ROIs on which the third type selection operation is performed. For example, the third type selection operation is used for determining elements not contained in the searching result.

For example, if the user desires to find images containing neither an airplane nor a car, the user may find two images, one contains an airplane and the other contains a car. The user respectively selects the airplane and the car from the two images, so as to configure the airplane and the car as elements not contained in the searching result. Thus, a quick searching may be performed to obtain all images containing neither airplane nor car. Optionally, the user may also select the elements not contained in the searching result from one image containing both an airplane and a car.

In embodiments, the operation in operation 101 includes a ROI selection operation and/or a searching content input operation; wherein the searching content input operation includes a text input operation and/or a voice input operation. The image management in operation 102 may include: providing corresponding images and/or video frames based on the selection operation and/or the searching content input operation.

For example, the image searched out may include a ROI belonging to the same category with the selected ROI and the category information matches the searching content, or include a ROI belonging to the same category with the selected ROI or the category information matches the searching content, or does not include a ROI belonging to the same category with the selected ROI and the category information matches the searching content, or does not include a ROI belonging to the same category with the selected ROI or the category information matches the searching content, etc.

In particular, the searching rule includes at least one of the following:

(A), If the searching content input operation is a first type searching content input operation, the provided corresponding images and/or video frames include: a ROI corresponding to all ROIs on which the first type searching content input operation is performed. For example, the first type searching content input operation is used for determining elements must be contained in the searching result.

For example, if the user desires to search for images containing both an airplane and a car, the user may find an image containing an airplane, select the airplane from the image, and input “car” via text or voice, so as to configure the airplane and the car as the elements must be contained in the searching result. Then, a quick searching may be performed to obtain images containing both an airplane and a car.

(B), If the searching content input operation is a second type searching content input operation, the provided corresponding images and/or video frames include: a ROI corresponding to at least one of the ROIs on which the second type searching content input operation is performed. For example, the second type searching content input operation is used for determining elements may be contained in the searching result.

For example, the user desires to search for images containing an airplane or a car, the user may find an image containing an airplane, the user selects the airplane from the image. Also, the user inputs “car” via text or voice. Thus, the airplane and the car are configured as elements may be contained in the searching result. Then, a quick searching may be performed to obtain all images containing an airplane or a car.

(C), If the searching content input operation is a third type searching content input operation, the provided corresponding images and/or video frames do not include: a ROI corresponding to the ROIs on which the third type searching content input operation is performed. For example, the third type searching content input operation is used for selecting elements not included in the searching result.

For example, the user desires to search for images containing neither airplane nor car. The user may find an image containing an airplane and select the airplane from the image. Also, the user inputs “car” via text or voice. Thus, the airplane and the car are configured as elements not included in the searching result. Then, a quick searching operation is performed to obtain all images containing neither airplane nor car.

In embodiments, the selection operation performed to the ROI in 101 may be detected in at least one of the following modes: camera preview mode, image browsing mode, thumbnail browsing mode, etc.

In view of the above, through searching for the images associated with the ROI of the user, the embodiments of the present disclosure facilitate the user to browse and search images quickly.

When displaying the images for quick browsing or the images searched out, priorities of the images may be determined firstly. According to the priorities of the images, the displaying order of the images is determined. Thus, the user firstly sees the images most conforming to the browsing and searching intent of the user, which improves the browsing and searching experience of the user.

In particular, the determination of the image priority may be implemented based on the following:

(A) Relevant data collected in a whole image level, such as shooting time, spot, number of browsed times, number of shared times, etc., then the priority of the image is determined according to the collected relevant data.

In embodiments, one data item in the relevant data collected in the whole image level may be considered individually to determine the priority of the image. For example, an image whose shooting time is closer to the current time has a higher priority. Or, a specific characteristic of the current time may be considered, such as holiday, anniversary, etc., thus an image matches the characteristic of the current time has a higher priority. An image whose shooting spot is closer to the current spot has a higher priority; an image which has been browsed for more times has a higher/lower priority; an image which has been shared for more times has a higher/low priority, etc.

In embodiments, various data items of the relevant data may be combined to determine the priority of the image. For example, the priority may be calculated based on a weighted score. Suppose that the time interval between the shooting time and the current time is t, the distance between the shooting spot and the current spot of the device is d, the number of browsed times is v, the number of shared times is s. In order to make the various kinds of data comparable, the data may be normalized to obtain t′, d′, v′ and s′, wherein t′, d′, v′, s′ ϵ[0,1]. The priority score may be obtained according to a following formula:

priority=αt′+βd′+γv′+μs′;

wherein α, β, γ, μ are weights for each data item and are used for determining the importance of respective data item. Their values may be defined in advance or determined by the user, or may vary with the user interested content, important time point, etc. For example, if the current time point is festival or an important time point configured by the user, the weight of α may be increased. If it is obtained that the user views pet images for more times than other images, it indicates that the user's current interested content is pet image content. At this time, the weight γ for the pet images may be increased.

(B) Relevant data collected in an object level, e.g. manual focus point, gaze heat map, confidence score of object classification, etc. Then, the priority of the image is determined according to the collected relevant data.

In embodiments, the priority of the image is determined according to the manual focus point. When the user shoots an image, the manual focus point is generally a ROI of the user. The device records the manual focus point and the object detected on this point. Thus, an image containing this object has a higher priority.

In embodiments, the priority of the image is determined according to gaze heat map. The gaze heat map represents a focus degree of the user on the image. On each pixel or object position, the numbers of focusing times and/or staying time of the user's sight are collected. The larger the number of times that the user focuses on and/or the longer the user's sight stays on a position, the image containing the object on this position has a higher priority.

In embodiments, the priority of the image is determined according to the confidence score of object classification. The classification confidence score of each object in the image reflects a possibility that a ROI belongs to a particular object category. The higher the confidence score, the higher the probability that the ROI belongs to the certain object category. An image containing an object with high confidence score has a high priority.

Besides considering each kind of the above data items individually, it is also possible to determine the priority of the image based on a combination of various data items of the object level, similar to the combination of various data items in the whole image level.

(C) Besides considering each object individually, a relationship between objects may also be considered. The priority of the image may be determined according to the relationship between objects.

In embodiments, the priority of the image is determined according to a semantics combination of objects. The semantic meaning of a single object may be used for searching in the album in a narrow sense, i.e., the user selects multiple objects in an image, and the device returns images containing the exact objects. On the other hand, a combination of several objects may be abstracted into semantic meaning in a broad sense, e.g., a combination of “person” and “birthday cake” may be abstracted into “birthday party”, whereas “birthday party” may not include “birthday cake”. Thus, the combination of object categories may be utilized to search for an abstract semantic meaning, and also associates the classification result of objects with the classification result of whole images. The conversion from the semantic category of multiple objects to the upper layer abstract category may be implemented via predefinition. For example, a combination of “person” and “birthday cake” may be defined as “birthday party”. It may also be implemented via machine learning. The objects contained in the image may be abstracted into an eigenvector, e.g., an image may include N kinds of objects, and thus an image may be expressed by an N-dimensional vector. Then, the image is classified into different categories via supervision learning or non-supervision learning manner.

In embodiments, the image priority is determined according to relative position of objects. Besides semantic information, relative position of the objects may also be used for determining the priority of the image. For example, when selecting ROIs, the user selects objects A and B, and object A is on the left side of object B. Thus, in the searching result, an image in which object A is on the left side of object B has a higher priority. Further, it is possible to provide a priority sorting rule based on more accurate value information. For example, in the image operated by the user, the distance between objects A and B is expressed by a vector [symbol] . In the images searched out, the distance between objects A and B is [symbol] , then the images may be sorted through calculating the difference between the two vectors.

(2) On Aspect of Image Organization Structure.

As to the image organization, the images may be aggregated or separated according to the attribute lists of the images, and a tree hierarchy may be constructed.

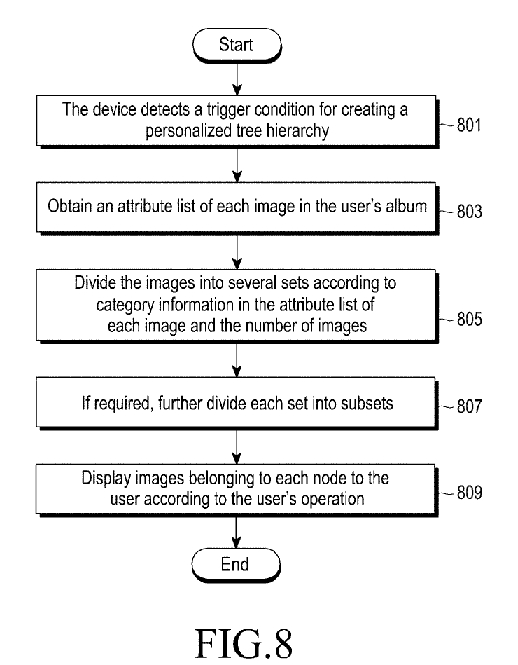

FIG. 8 is a flowchart illustrating a process of implementing personalized tree hierarchy according to embodiments of the present disclosure.

The device firstly detects a trigger condition for constructing the tree hierarchy, e.g., the number of images reaches a threshold, the user triggers manually, etc. at operation 801. Then, the device retrieves the attribute list of each image in the album at operation 803, divides the images into several sets according to the category information (category of the whole image and/or category of the ROI) in the attribute list of each image and the number of images at operation 805, each set is a node of the tree hierarchy. If required, each set may be further divided into subsets at operation 807. The device displays the images belonging to each node to the user according to the user's operation at operation 809. In the tree hierarchy, a node on each layer denotes a category. The closer to the root node, the category becomes more abstract. The closer to the leaf node, the category becomes more specific. A leaf node is a ROI or an image.

Further, it is possible to perform a personalized adjustment to the tree hierarchy according to image distributions in different user albums. For example, the album of user A includes many vehicle images, whereas the album of another user B includes fewer vehicle images. Thus, more layers may be configured in the tree about vehicles in the album of user A, whereas fewer layers may be configured for user B. The user may have a quick switch between layers freely, so as to achieve the objective of quick view.

In embodiments, the image management based on the ROI of the user in operation 102 includes: displaying thumbnails in a tree hierarchy; and/or displaying whole images in the tree hierarchy.

In embodiments, the generation of the tree hierarchy may include: based on an aggregation operation, aggregating images including ROIs with the same category label; based on a separation operation, separating images including ROIs with different category labels; based on a tree hierarchy construction operation, constructing a tree hierarchy containing layers for images after the aggregation processing and/or separation processing.

In embodiments, the method may further include at least one of the following: based on a category dividing operation, performing a category dividing processing to the same layer if the number of leaf nodes of the same layer of the tree hierarchy exceeds a predefined threshold; based on a first type trigger operation selecting a layer in the tree hierarchy, displaying images belonging to the selected layer by thumbnails; based on a second type trigger operation selecting a layer in the tree hierarchy, displaying images belonging to the selected layer in whole images; based on a third type trigger operation selecting a layer in the tree hierarchy, displaying a lower layer of the selected layer; based on a fourth type trigger operation selecting a layer in the tree hierarchy, displaying an upper layer of the selected layer; based on a fifth triggering operation of a selected layer in the tree hierarchy, displaying all images contained in the selected layer, etc.

In view of the above, the embodiments of the present disclosure optimize the image organization structure based on ROI of the user. On various kinds of interfaces, the user is able to have a quick switch between layers, so as to achieve the objective of quick view of the images.

(3) Personalized Category Definition and Accurate Classification of User's Album.

When performing personalized album management, the user may provide a personalized definition to a category of images and ROIs contained in the images. For example, a set of images is defined as “my paintings”. For another example, regions containing dogs in another set of images are defined as “my dog”.

Hereinafter, the classification of images is taken as an example to describe the personalized category definition and accurate classification of the user album. For the ROIs, the similar operations and technique may be adopted to realize the personalized category definition and accurate classification.

In various album management products, users always participate passively. What kind of management policy is provided by the product is completely determined by developers. In order to make the product applicable for more users, the management policy determined by the developers is usually generalized. Therefore, existing album management function cannot meet the personalized requirement of users.

In addition, in the existing products, the classification result in the cloud and that in the mobile device are independent from each other. However, the combination of them is able to make the album management more accurate, intelligent and personalized. Compared with the mobile device, the cloud server has better computing and storing abilities, therefore is able to realize various requirements of users via more complex algorithms. Therefore, resources of the cloud end need to be utilized reasonably to provide better experience to users.

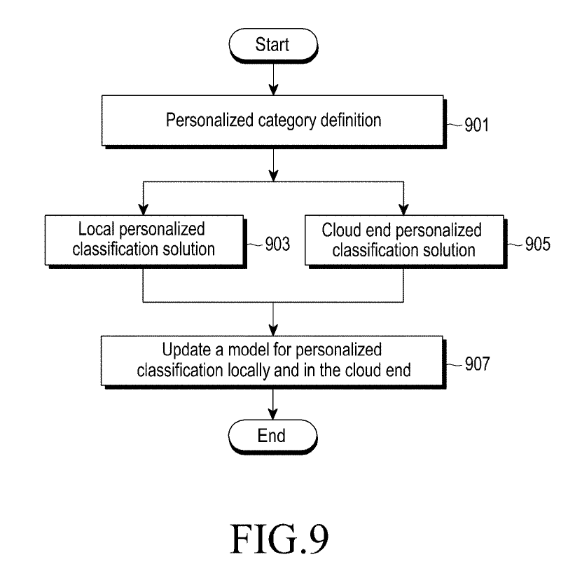

FIG. 9 is a flowchart illustrating a process of implementing personalized category classification according to embodiments of the present disclosure.

Firstly, the device defines a personalized category according to a user operation at operation 901. The classification based on the personalized category may be implemented via two solutions: a local solution at operation 903 and a cloud end solution at operation 905, such that models for personalized classification at the local end and the cloud end may be updated at operation 907, and classification results of the updated models may be combined to obtain an accurate personalized category classification result.

In order to meet the user's requirement for the personalized category, definition of the personalized category need to be determined firstly. The method for defining the personalized category may include at least one of the following:

(A) Define by the user actively, i.e., inform the device which images should be classified into which category. For example, the device assigns an attribute list for each image. The user may add a category name in the attribute list. The number of categories may be one or more. The device assigns a unique identifier for the category name added by the user, and classifies the images with the same unique identifier into one category.

(B) Define the category according to a user's natural operation to the album. For example, when managing images in the album, the user moves a set of images into a folder. At this time, the device determines according to the operation of the user to the album that this set of images forms a personalized category of the user. Subsequently, when an image emerges, it is required to determine whether this image belongs to same category with the set of images. If yes, the image is automatically displayed in the folder created by the user, or prompt is provided to the user asking whether the image should be displayed in the folder created by the user.

(C) Implement the definition of category according to another natural operation of the user on the device. For example, when the user uses a social application, the device defines a personalized category for images in the album according to a social relationship through analyzing a sharing operation of the user. Through analyzing the behavior of the user in the social application, a more detailed personalized category may be created. For example, the user may say “look, my dog is chasing a butterfly” when sharing a photo of his pet with his friend. At this time, the device is able to know which dog among many dogs in the album is the pet of the user. At this time, a new personalized category “my dog” may be created.

(D) The device may automatically recommend the user to perform a further detailed classification. Through analyzing the user's behavior, it is possible to recommend the user to classify the images in the album in further detail. For example, the user uses a searching engine on the Internet. According to a searching keyword of the user, the user's point of interest may be determined. The device asks the user whether to further divide the images relevant to the searching keyword in the device. The user may determine a further classification policy according to his requirement, so as to finish the personalized category definition. The device may also recommend the user to further classify the images through analyzing images in an existing category. For example, if the number of images in a category exceeds a certain value, the excessive images bring inconvenience to the user during viewing, managing and sharing procedure. Therefore, the device may ask the user whether to divide this category. The user may determine each category according to his point of interest to finish the personalized category definition.

After the user defines the personalized category, the implementation for the personalized category classification may be determined according to a varying degree of the category, which may include at least one of the following:

(A) If the personalized category is within predefined categories of a classification model, the predefined categories in the classification model are re-combined in the device or at the cloud end, so as to be consistent with the personalized definition of the user. For example, the predefined categories in the classification model are “white cat”, “black cat”, “white dog”, “black dog”, “cat”, and “dog”. The personalized categories defined by the user are “cat” and “dog”. Then, the “white cat” and “black cat” in the classification model are combined into “cat”, and the “white dog” and “black dog” in the classification model are combined into “dog”. For another example, suppose that the personalized categories defined by the user are “white pet” and “black pet”. Then, the predefined categories in the classification model are re-combined, i.e., “white cat” and “white dog” are combined into “white pet”, and “black cat” and “black dog” are combined into “black pet”.

(B) If the personalized category is not included in the predefined categories of the classification model, it cannot be obtained through re-combining predefined categories in the classification model. At this time, the classification model may be updated. The classification model may be updated in the device locally or in the cloud end. The set of images in the personalized category defined according to the above manner may be utilized to train an initial model for performing image personalized category classification. For example, when browsing an image, the user changes the label of an image of a painting from “painting” to “my painting”. After detecting the user's modification of the image attribute, the device defines “my painting” as a personalized category, and takes the image with the modified label as training sample for the personalized category.

In a short time that the personalized category is defined, there may be few training samples. The classification of the initial model may be unstable. Therefore, when an image is classified into a new category, the device may interact with the user, e.g., ask the user whether the image should belong to the personalized category. Through the interaction with the user, the device is able to determine whether the image is correctly classified into the personalized category. If the classification is correct, the image is taken as a positive sample for the personalized category; otherwise, the image is taken as a negative sample for the personalized category. As such, it is possible to collect more training samples. Through multiple times of iterated trainings, the performance of the personalized category model may be improved, and a stable classification performance may be finally obtained. If a main body of an image is text, text recognition may be performed to the image and the image is classified according to the recognition result. Thus, text images of different subjects can be classified into respective categories. If the model is trained at the cloud end, a difference between a new personalized category model and the current model is detected, and the different part is selected and is distributed to the device via an update package. For example, if a branch for personalized category classification is added to the model, merely the newly added branch needs to be transmitted and it is not required to transmit the whole model.

In order to classify the images in the user's album more accurately, interaction between a local classification engine and a cloud classification engine may be considered. The following situations may be considered.

(A) In the case that the user does not respond. The cloud end model is a full-size model. For the same image, the local engine and the cloud engine may have different classification results. Generally, the full-size model of the cloud end has a more complicated network structure. Therefore, it is usually better than the local model on classification accuracy. If the user configures that the classification result should refer to the result of the cloud end, the cloud end processes the image to be classified synchronously. In the case that the classification results are different, a factor such as classification result confidence score needs to be considered. For example, if the classification confidence score of the cloud end is higher than a threshold, it is regarded that the image should be classified according to the classification result of the cloud end, and the local classification result of the device is updated according to the classification result of the cloud end. Information of erroneous classification of the local end is also reported to the cloud end, for subsequent improvement of the local model. The classification error information reported to the cloud end may include the image which is erroneously classified, the erroneous classification result of the device, and the correct classification result (the classification result of the cloud end). The cloud end adds the image to a training set of a related category according to the information, e.g., adds to a negative sample set of an erroneous classification category, a positive sample set of a missed classification category, so as to train the model and improve the performance of the model.

Suppose that the device was not connected with the cloud end before (e.g. due to network reasons), or the user configured that the classification result does not refer to the cloud end result, when the connection with the cloud end is subsequently established, or when the user configures that the classification result should refer to the cloud end result, the device may determine the confidence score of the label according to the score of an output category. If the confidence score is relatively low, it is possible to ask the user in batch about the correct label of the images when the user logs in the cloud end, so as to update the model, or it is possible to design a game, such that the user may finish the task easily.

(B) The user may correct the classification result of the cloud end or the terminal. When the user corrects the label of an image which was erroneous classified, the terminal uploads the erroneous classification result to the cloud end, including the image which is erroneously classified, the category in which the image is erroneously classified, and the correct category designated by the user. When the user feeds back image, the cloud end may collect images fed back by a plurality of different users for training. If the samples are insufficient, similar images may be crawled from network to enlarge the number (amount) of samples. It may be labeled as a user designated category, and model training may be started. The above model training procedure may be implemented by the terminal.

If the number of collected and crawled images is too small to train the new model, the images may be mapped locally to a space of a preconfigured dimension according to characteristic of the images. In this space, the images are aggregated to obtain respective aggregation center. According to a distance between the mapped position of the image in the space and the respective aggregation center, the category that each tested image belongs to is determined. If the category corrected by the user is near the erroneous category, images having similar characteristic with the image which was erroneously classified are identified with a higher layer concept. For example, an image of “cat” is erroneously classified into “dog”, but the position of the image in the characteristic space is nearer to the aggregation center of “cat”, thus it cannot be determined that the image belongs to “dog” based on distance. Then, the category of the image is raised by one level, and is labeled as “pet”.

If the user feeds back some images, among them there may be erroneously operated images. For example, an image of “cat” is corrected classified into “cat”, but the user erroneously labels it as “dog”. This operation is a kind of erroneous operation. A determination may be performed for the feedback (especially when erroneous feedback is provided for labels with high confidence score). An erroneous operation detecting model may be created in background for performing the determination of such image. For example, samples for training the model may be obtained via interacting with the user. If the classification confidence score of an image is higher than a threshold but the user labels the sample as belonging to another category, it is possible to ask the user whether to change. If the user selects to not change, the image may be seen as a sample for training the erroneous operation model. The model may have a low speed and is dedicated for correction of erroneous images. When the erroneous operation detection model detects an erroneous operation of the user, a prompt may be provided to the user or the erroneously operated image may be excluded from the training samples.

(C) In the case that there is a difference between local images and cloud end images. When there is no image upload, the terminal may receive a synchronous update request from the cloud end. During the image upload procedure, a real-time classification operation may be performed once the upload of an image is finished. In order to reduce bandwidth occupation, some of the images may be uploaded. It is possible to select which images are uploaded according to the classification confidence score of the terminal. For example, if the classification confidence score of an image is lower than a threshold, it is regarded that the classification result of the image is unreliable and it is required to upload it to the cloud end for re-classification. If the classification result is different from the local classification result, the local classification result is updated synchronously.

(4) Image Transmission and Key-Point Display Based on ROI of the User.

When detecting an image data transmission request, the device determines a transmission network type and transmission amount, and adopts different transmission modes according to the transmission network type and the transmission amount. The transmission modes include: transmitting image with whole image compression, transmitting image with partial image compression, and transmitting image without compression, etc.

In the partial image compression mode, a compression with low compression ratio is performed to the ROI of the user, so as to keep rich details of this region. A compression with high compression ratio is performed to regions other than the ROI, so as to save the power and bandwidth during the transmission.

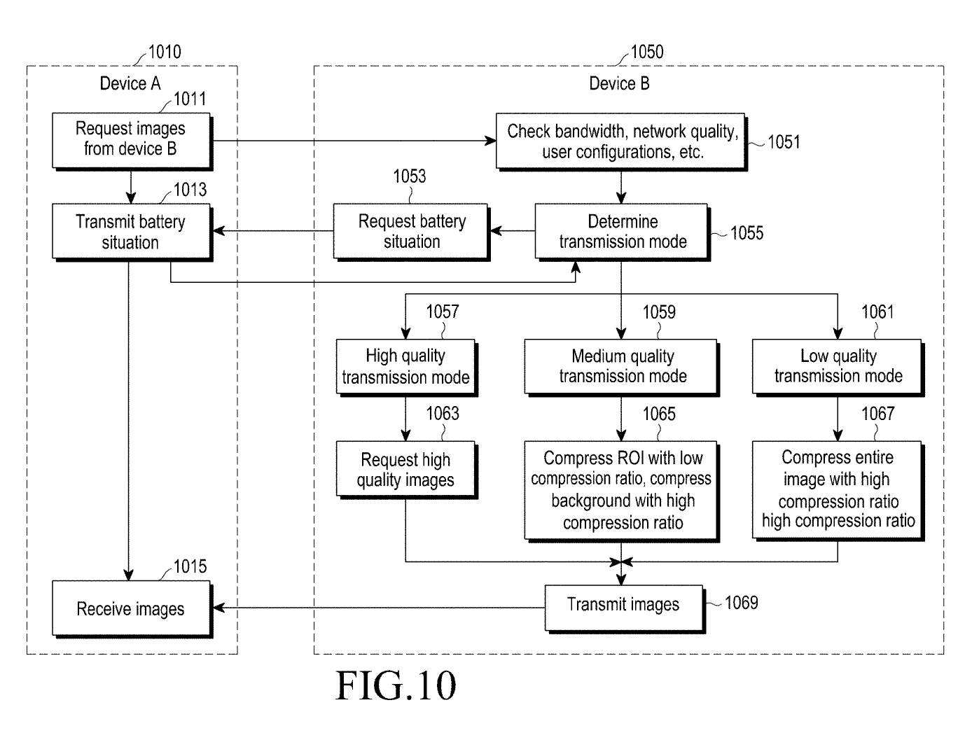

FIG. 10 is a flowchart illustrating selection of different transmission modes according to various embodiments of the present disclosure. Here, each of device A 1010 and device B 1050 shown in FIG. 10 includes an image management apparatus 3300 as shown in FIG. 33, and performs operations according to the embodiments of the present disclosure as follows.

Device A 1010 requests an image from device B 1050 at operation 1011. Device B 1050 determines a transmission mode at operation 1055 through checking various factors at operation 1051, such as network bandwidth, network quality or user configurations, etc. In some cases, device B 1050 requests additional information from device A 1010 at operation 1053, e.g., remaining power of device A 1010, etc. (at operation 1013), so as to assist the determination of the transmission mode. The transmission mode may include the following three modes: 1) high quality transmission mode at operation 1057, e.g., no compression is performed to the image (i.e., a high quality image is requested at operation 1063); 2) medium quality transmission mode at operation 1059, e.g., low compression ratio compression is performed to the ROI and high ratio compression is performed to the background at operation 1065; 3) low quality transmission mode at operation 1061, e.g., compression is performed to the whole image at operation 1067. Finally, device B 1050 transmits the image to device A 1010 at operation 1069. Then, device A 1010 receives the image from device B 1050 at operation 1015. In some cases, device B 1050 may also initiatively transmit the image to device A 1010.

In embodiments, the performing the image management in operation 102 include: compressing the image according to an image transmission parameter and the ROI in the image, and transmitting the compressed image; and/or, receiving an image transmitted by a server, a base station or a user device, wherein the image is compressed according to an image transmission parameter and the ROI. The image transmission parameter includes: number of images to be transmitted, transmission network type and transmission network quality, etc.

The procedure of compressing the image may include at least one of:

(A) If the image transmission parameter meets a ROI non-compression condition, compressing the image except for the ROI of the image, and not compressing the ROI of the image.

For example, if it is determined that the number of images to be transmitted is within a preconfigured appropriate range according to a preconfigured threshold for the number of images to be transmitted, it is determined that the ROI non-compression condition is met. At this time, regions except for the ROI in the image are compressed, and the ROI of the image to be transmitted is not compressed.

(B) If the image transmission parameter meets a differentiated compression condition, regions except for the ROI of the image to be transmitted are compressed at a first compression ratio, and the ROI of the image to be transmitted is compressed at a second compression ratio, wherein the second compression ratio is lower than the first compression ratio.

For example, if the transmission network is a wireless mobile communication network, it is determined that the differentiated compression condition is met. At this time, all regions in the image to be transmitted are compressed, wherein the regions except for the ROI are compressed at a first compression ratio and the ROI is compressed at a second compression ratio, the second compression ratio is lower than the first compression ratio.

(C) If the image transmission parameter meets an undifferentiated compression condition, regions except for the ROI in the image to be transmitted as well as the ROI in the image to be transmitted are compressed at the same compression ratio.

For example, if it is determined according to a preconfigured transmission network quality threshold that the transmission network quality is poor, it is determined that the undifferentiated compression condition is met. At this time, regions except for the ROI in the image to be transmitted as well as the ROI in the image to be transmitted are compressed at the same compression ratio.

(D) If the image transmission parameter meets a non-compression condition, the image to be transmitted is not compressed.

For example, if it is determined according to the preconfigured transmission network quality threshold that the transmission network quality is good, it is determined that the non-compression condition is met. At this time, the image to be transmitted is not compressed.

(E) If the image transmission parameter meets a multiple compression condition, the image to be transmitted is compressed and is transmitted via one or more number of times.

For example, if it is determined according to the preconfigured transmission network quality threshold that the transmission network quality is very poor, it may be determined that the multiple compression condition is met. At this time, compression operation and one or more transmission operations are performed to the image to be transmitted.

In embodiments, the method may include at least one of the following.

If the number of images to be transmitted is lower than a preconfigured first threshold, it is determined that the image transmission parameter meets the non-compression condition; if the number of images to be transmitted is higher than the first threshold but lower than a preconfigured second threshold, it is determined that the image transmission parameter meets the ROI non-compression condition, wherein the second threshold is higher than the first threshold; if the number of images to be transmitted is higher than or equal to the second threshold, it is determined that the image transmission parameter meets the undifferentiated compression condition; if an evaluated value of the transmission network quality is lower than a preconfigured third threshold, it is determined that the image transmission parameter meets the multiple compression condition; if the evaluated value of the transmission network quality is higher than or equal to the third threshold but lower than a fourth threshold, it is determined that the image transmission parameter meets the differentiated compression condition, wherein the fourth threshold is higher than the third threshold; if the transmission network is a free network (e.g., Wi-Fi network), it is determined that the image transmission parameter meets a non-compression condition; if the transmission network is an operator's network, the compression ratio is adjusted according to a charging rate, the higher the charging rate, the higher the compression ratio.

In fact, embodiments of the present disclosure may also determine whether any one of the above compression conditions is met according to a weighted combination of the above image transmission parameters, which is not repeated in the present disclosure.

In view of the above, through performing differentiated compression operations to the image to be transmitted based on the ROI, the embodiments of the present disclosure are able to save the power and network resources during the transmission procedure, and also ensure that the ROI can be clearly viewed by the user.

In embodiments, the image management in operation 102 includes at least one of the following.

(A) If the size of the screen is smaller than a preconfigured size, a category image or category name of the ROI is displayed.

(B) If the size of the screen is smaller than the preconfigured size and the category of the ROI is selected based on user's operation, the image of the category is displayed, and other images in the category may be displayed based on a switch operation of the user.

(C) If the size of the screen is smaller than the preconfigured size, an image is displayed based on the number of ROIs.

If the size of the screen is smaller than the preconfigured size, the displaying the image based on the number of ROIs may include at least one of:

(C1) If the image does not contain ROI, displaying the image via thumbnail or reducing the size of the image to be appropriate to the screen for display.

(C2) If the image contains one ROI, displaying the ROI.

(C3) If the image contains multiple ROIs, displaying the ROIs alternately, or, displaying a first ROI in the image, and switching to display another ROI in the image based on a switching operation of the user.

In view of the above, if the screen of the device is small, the embodiments of the present disclosure improve the displaying efficiency of the ROI through especially displaying the ROI.

(5) Quick Sharing Based on the ROI of the Image.

The device establishes association between images according to an association of ROIs. The establishing method includes: detecting images of same contact, with similar semantic contents, same geographic position, particular time period, etc. The association between images may be the same contact, from the same event, containing the same semantic concept, etc.

In the thumbnail mode, associated images may be identified in a predetermined method and a prompt of one-key sharing may be provided to the user.

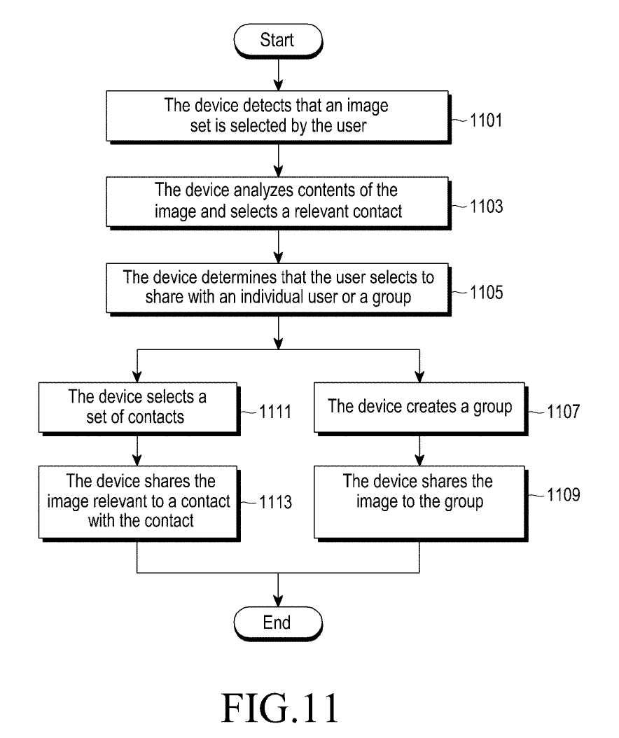

FIG. 11 is a flowchart illustrating initiating image sharing by a user according to various embodiments of the present disclosure. The device detects that an image set is selected by the user at operation 1101. The device determines relevant contact according to sharing history of the user as well as an association degree between the selected image and the images having been shared at operation 1103. The device determines that the user selects to share the image set with an individual person or a group at operation 1105. If the user selects to share to a group, the device creates a group and shares the image set to the group at operations 1107 and 1109. If the user selects to share with an individual person, the device shares the image set with the person through multiple transmissions of the image set at operation 1111 and 1113.

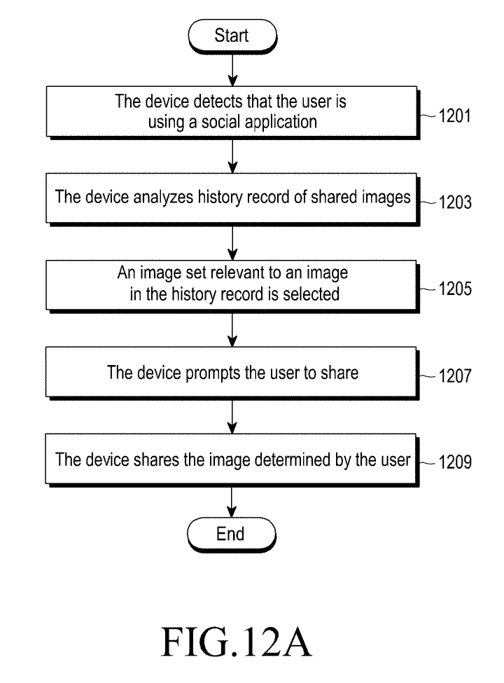

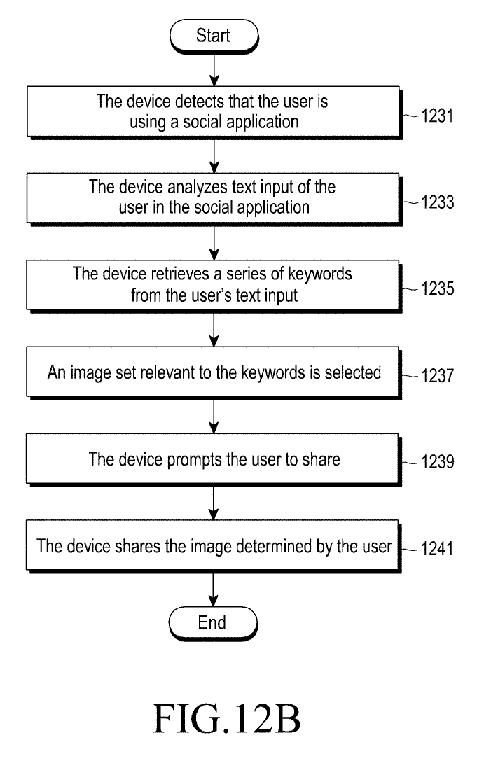

FIGS. 12A to 12B are flowcharts illustrating image sharing when the user uses a social application according to various embodiments of the present disclosure. When the device detects that the user is using a social application, e.g. instant messaging application at operation 1201, the device selects from album an image set consisting of unshared images at operation 1205 according to sharing history of the user in the social application at operation 1203, and asks the user whether to share the image set at operation 1207. If the device detects the user's confirmation information, the device shares the image set at operation 1209. In addition, the device may further determine the image set to be shared through analyzing the text input by the user in the social application, as shown in FIG. 12B at operations 1231 to 1241.

In embodiments, when detecting a sharing action of the user, the device shares a relevant image with respective contact according to the contacts contained in the image, or automatically creates a group chat containing relevant contacts and shares the relevant image with the respective contacts. In the instant messaging application, input of the user may be analyzed automatically to determine whether the user wants to share image. If the user wants to share image, content that the user wants to share is analyzed, and relevant region is cropped from the image automatically and provided to the user for selection and sharing.

In embodiments, the image management in operation 102 may include: determining a sharing object; sharing the image with the sharing object; and/or determining an image to be shared based on a chat object or chat content with the chat object, and sharing the image to be shared with the chat object. The embodiments of the present disclosure may detect the association between the ROIs, establish an association between images according to the detecting result, and determine the sharing object or the image to be shared and share the associated image. In embodiments, the association between the ROIs may include: association between categories of the ROIs, time association of the ROIs; position association of ROIs, person association of the ROIs, etc.

In particular, the sharing the image based on the ROI of the image may include at least one of:

(A) Determining a contact group to which the image is shared based on the ROI of the image; sharing the image to the contact group via a group manner based on a group sharing operation of the user with respect to the image.

(B) Determining contacts with which the image is to be shared based on the ROI of the image, and respectively transmitting the image to each contact with which the image is to be shared based on each individual sharing operation of the user, wherein the image shared with each contact contains a ROI corresponding to the contact.

(C) If a chat sentence between the user and a chat object corresponds to the ROI of the image, recommending the image to the user as a sharing candidate.

(D) If the chat object corresponds to the ROI of the image, recommending the image to the user as a sharing candidate.

In embodiments, after image is shared, the shared image is identified based on shared contacts.

In view of the above, embodiments of the present disclosure share images based on ROI of the image. Thus, it is convenient to select the image to be shared from a large number of images. And it is convenient to share the image to multiple application scenarios.

(6) Image Selection Method Based on ROI.

For example, the image selection method based on ROI may include: a selection method from image to text.

In this method, images within a certain time period are aggregated and separated. Contents in the images are analyzed, so as to assist, in combination of the shooting position and time, the aggregation of images of the same time period and about the same event into one image set. A text description is generated according to contents contained in the image set and an image tapestry is generated automatically. During the generation of the image tapestry, the positions of image and a combining template are adjusted automatically according to the regions of the image to display important regions in the image tapestry, and the original image may be viewed via a link from the image tapestry.

In embodiments, the image management in operation 102 may include: selecting images based on the ROI; generating an image tapestry based on the selected images, wherein the ROIs of respective selected images are displayed in the image tapestry. In this embodiment, the selected images may be automatically displayed by system.

In embodiments, the method may further include: detecting a selection operation of the user selecting a ROI in the image tapestry, displaying a selected image containing the selected ROI. In this embodiment, it is possible to display the selected image based on the user's selection operation.

For another example, the image selection method based on the ROI may include: a selection method from text to image.

In this embodiment, the user inputs a paragraph of text. Then, the system retrieves a keyword from the text and selects a relevant image from an image set, crops the image if necessary, and inserts the relevant image or a region of the image in the paragraph of text of the user.

In embodiments, the image management in operation 102 may include: detecting text input by the user, searching for an image containing a ROI associated with the input text; and inserting the found image containing the ROI into the text of the user.

(7) Image Conversion Method Based on Image Content.

The system may analyze an image in the album, and perform a natural language processing to characters in the image according to appearance and time of the image.

For example, in the thumbnail mode, the device identifies text images from the same source via some manners, and provides a combination recommendation button to the user. When detecting that the user clicks the button, the system enters into an image conversion interface. On this interface, the user may add or delete images. Finally, a text file is generated based on the adjusted images.

In embodiments, the method may further include: when determining that multiple images come from the same file, automatically aggregating the images into a file, or aggregating the images into a file based on a user's trigger operation.

In view of the above, the embodiments of the present disclosure are able to aggregate images and generate a file.

(8) Intelligent Deletion Recommendation Based on Image Content.

For example, content of an image may be analyzed based on the ROI. Based on the image visual similarity, content similarity, image quality, contained content, etc., images which are visually similar, having similar content, with low image quality and without semantic object are recommended to the user to be deleted. The image quality includes: aesthetic degree, which may be determined according to the position of ROI in the image, relationship between different ROIs.

On the deletion interface, the image recommended to be deleted may be displayed to the user in groups. During the display, one image may be configured as a reference, e.g., the first image, the image with the best quality, etc. On other images, difference compared with the reference image is displayed.

In embodiments, the image management in operation 102 may include at least one of:

(A) Based on a category comparison result of ROIs in different images, automatically deleting an image or recommending deleting an image.

(B) Based on ROIs of different images, determining a semantic information including degree of each image, and automatically deleting an image or recommending deleting an image based on a comparing result of the semantic information including degrees of different images.

(C) Based on relative positions of ROIs in different images, determining a score for each image, and automatically deleting or recommending deleting an image according to the scores.

(D) Based on the absolute position of at least one ROI in different images to determine scores of the images, and automatically deleting or recommending deleting an image based on the scores.

In view of the above, the embodiments of the present disclosure implement intelligent deletion recommendation based on ROI, which is able to save storage space and improve image management efficiency.

The above are various descriptions to the image management manners based on ROI. Those with ordinary skill in the art would know that the above are merely some examples and are not used for restricting the protection scope of the present disclosure.

Hereinafter, the image management based on ROI is described with reference to some examples.

### Embodiment 1: Quick View in an Image View Interface

Operation 1: A Device Prompts a User about a Position of a Selectable Region in an Image.

Herein, the device detects a relative position of the user's finger or a stylus pen on the screen, and compares this position with the position of the ROI in the image. If the two positions overlap, the device prompts the user that the ROI is selectable. The method for prompting the user may include highlighting the selectable region in the image, adding a frame or vibrating the device, etc.

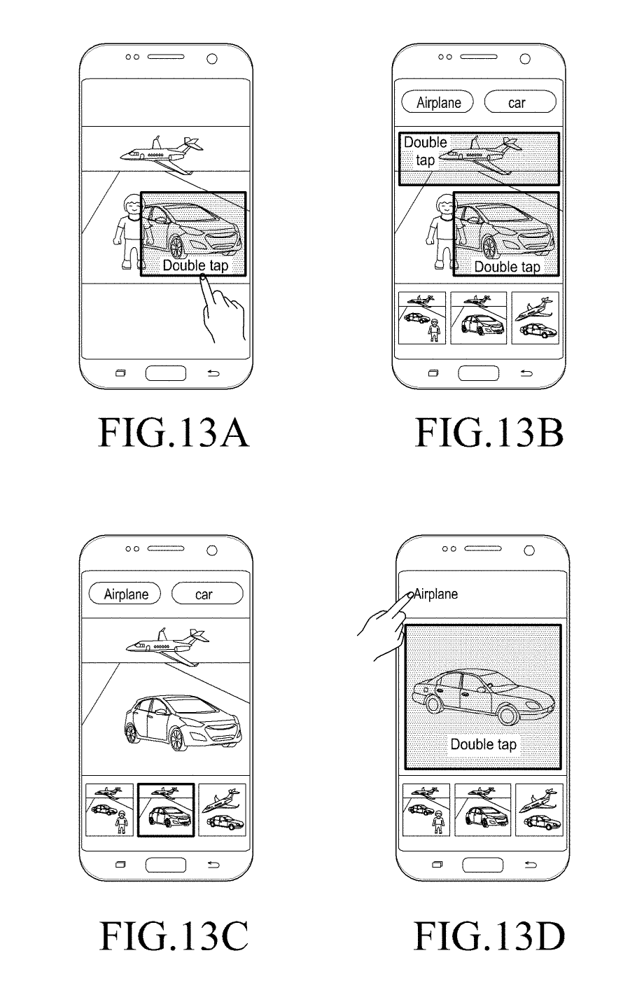

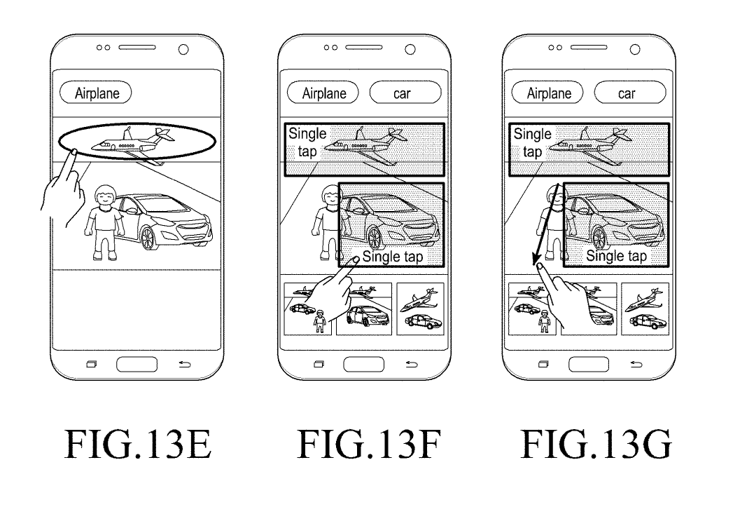

FIGS. 13A to 13G are schematic diagrams illustrating a quick view in an image view interface according to various embodiments of the present disclosure.

Referring to FIG. 13A, when the device detects that the user's finger touches the position of a car, the device highlights the region where the car is located, prompting that the car is selectable.

It should be noted that, operation 1 is optional. In a practical application, each region where an object is located may be selectable. The user is able to directly select an appropriate region according to an object type. For example, the device stores an image of a car. The region where the car is located is selectable. The device does not need to prompt the user whether the region of the car is selectable.

Operation 2: The Device Detects an Operation of the User on the Image.

The device detects the operation of the user on the selectable region. The operation may include: single tap, double tap, sliding, circling, etc. Each operation may correspond to a specific searching meaning, including “must contain”, “may contain”, “not contain”, “only contain”, etc.

Referring to FIGS. 13B, 13F and 13G, the single tap operation corresponds to “may contain”; the double tap operation corresponds to “must contain”; the sliding operation corresponds to “not contain”; and the circling operation corresponds to “only contain”. The searching meaning corresponding to the operations may be referred to as searching criteria. The searching criteria may be defined by system or by the user.

Besides the physical operations on the screen, it is also possible to operate each selectable region via a voice input. For example, if desiring to select the car via voice, the user may say “car”. The device detects the user's voice input “car” and determines to operate the car. If the user's voice input corresponds to “must contain”, the device detects that the user's voice input must be contained and determines to return images must containing the car to the user.

The user may combine the physical operation and the voice operation, e.g., operate the selectable region via a physical operation and determine an operating manner via voice. For example, the user desires to view images must contain a car. The user clicks the region of the car in the image and inputs must contain via voice. The device detects the user's click on the region of the car and the voice input must contain, and determines to return images must containing cars to the user.

After detecting the user's operation, the device displays the operation of the user via some manners to facilitate the user to perform other operations.

Referring to FIG. 13C, text is displayed to show the selected content. Also, different colors may be used for denoting different operations. The user may also cancel a relevant operation through clicking the minus sign on the icon.

For example, the user desires to find images containing merely car. The user circles a car in an image. At this time, the device detects the circling operation of the user on the region of the car of the image, and determines to provide images containing only cars to the user.

For example, the user desires to find images containing both car and airplane. The user double taps a car region and an airplane region in an image. At this time, the device detects the double tap in the car region and the airplane region in the image, and determines to provide images containing both car and airplane to the user.

For another example, the user desires to find images containing a car or an airplane. The user single taps a car region and an airplane region in an image. At this time, the device detects the single tap operations of the user in the car region and the airplane region of the image and determines to provide images containing a car or an airplane to the user.

For still another example, the user desires to find images not containing car. The user may draw a slash in a car region of the image. At this time, the device detects the slash drawn by the user in the car region of the image, and determines to provide images not containing car to the user.

Besides the above different manners of selection operations, the user may also write by hand on the image. The handwriting operation may correspond to a particular kind of searching meaning, e.g. above mentioned “must contain”, “may contain”, “not contain”, “only contain”, etc.

For example, the handwriting operation corresponds to “must contain”. When desiring to find images containing both car and airplane via an image containing car but not airplane, the user may write airplane in any region of the image by hand. At this time, the device analyzes that the handwritten content of the user is “airplane”, and determines to provide images containing both car and airplane to the user.

Operation 3: The Device Searches for Images Corresponding to the User's Operation.

After detecting the user's operation, the device generates a searching rule according to the user's operation, searches for relevant images in the device or the cloud end according to the searching rule, and displays thumbnails of the images to the user on the screen. The user may click the thumbnails to switch and view the corresponding images. Optionally, the original images of the found images may be displayed to the user on the screen.

When displaying the searching result, the device may sort the images according to a similarity degree between the images and the ROI used in searching. The images with high similarity degrees are ranked in the front and those with low similarity degrees are ranked behind.

For example, the device detects that the user selects the car in the image as a searching keyword. In the searching result fed back by the device, the images of cars are displayed in the front. Images containing buses are displayed behind the images of cars.

For example, the device detects that the user selects a person in the image as a searching keyword. In the searching result fed back by the device, images of a person with the same person ID as that selected by the user are displayed in the first, then the images of persons have similar appearance or clothes are displayed, and finally images of other persons are displayed.

Referring to FIG. 13A, the device detects that the image contains a car and highlights the region of the car to prompt the user that this region is selectable.

Referring to FIG. 13B, when the device detects that the user double taps the car and the airplane in the image, the airplane and the car “must be contained”, the device determines that the user wants to view images containing both an airplane and a car. Therefore, all candidate images displayed by the device contain an airplane and a car, as shown in FIG. 13C. Through this embodiment, when the user wants to find images containing both an airplane and a car, the user merely needs to find one image containing an airplane and a car, then a quick searching can be performed based on this image to find all images containing an airplane and a car. Thus, the image viewing and searching speed is improved.

The device detects that the image contains a car and highlights the region of the car to prompt the user that the region is selectable, as shown in FIG. 13D. When the device detects that the user double taps the car and writes airplane by hand, the airplane and the car “must be contained”, the device determines that the user wants to view images containing both an airplane and a car. Therefore, all candidate images displayed by the device contain an airplane and a car, i.e., the meanings of double tap and handwriting are the same, both are “must contain”. This kind of operation does not exclude other contents, e.g. the returned images may further contain people.

When the user wants to find images containing both an airplane and a car, it may be impossible to find an image containing both airplane and car due to some reasons such as the number of images is too large. Through this embodiment, it is merely need to find one image containing a car, then quick searching can be performed based on the image and handwritten content of the user to obtain all images containing an airplane and a car. Thus, image viewing and searching speed is improved.

Referring to FIG. 13E, after detecting that the airplane is circled, the device determines that the airplane is “contained only”, this kind of operation excludes other content. Thus, the device determines that the user wants to view images containing merely an airplane. Therefore, the candidate images displayed by the device contain merely an airplane. Through this embodiment, when the user wants to view images containing merely airplane, the user may have a quick searching through any image containing an airplane. Thus, the image viewing and searching speed is increased.

Referring to FIG. 13F, after the device detects that the user single taps the airplane and the car, the airplane and the car “may be contained”. The device determines that the user wants to view images containing an airplane or a car. Therefore, candidate images displayed by the device may include an airplane or a car. They may appear together or alone. This kind of operation does not exclude other contents. Through this embodiment, when desiring to view images containing an airplane or a car, the user is able to have a quick search through any image containing both an airplane and a car. Thus, the image viewing and searching speed is increased.

Referring to FIG. 13G, when the device detects that the user strokes out a person, human is “not contained”. The candidate images displayed by the device absolutely contain no person. These operations may be combined. For example, the device detects that the user single taps the airplane, double taps the car, strokes out the person, then the airplane “may be contained”, the car “must be contained”, and human is “not contained”. The candidate images displayed by the device may include an airplane, must include a car and absolutely not includes human. Through this embodiment, when desiring to find images containing a certain object, the user may have a quick searching via any image containing this object. Thus, the image viewing and searching speed is increased.

In some cases, the user's desired operation and that recognized by the device may be inconsistent. For example, the user double taps the screen, but the device may recognize it as a single tap operation. In order to avoid the inconsistency, after recognizing the user's operation, the device may display different operations via different manners.

As shown in FIGS. 13A to 13G, after recognizing the double tap operation to the airplane in the image, the device displays airplane in the upper part of the screen, and identifies the airplane as must be contained via a predefined color. For example, the airplane may be identified as must be contained via the color of red. After recognizing the single tap operation to the car in the image, the device displays car on the upper part of the screen, and identifies the car as may be contained via a predefined color. For example, the car may be identified as may be contained via a color of green. Through this embodiment, the user is able to determine whether the recognition of the device is correct and may have an adjustment in case of erroneous recognition, which improves viewing and searching efficiency.

### Embodiment 2: Quick View Based on Multiple Images

The user may hope to find images containing both a dog and a person. However, if there are a large number of images, it may be hard for the user to find an image containing both dog and person. Therefore, embodiments of the present disclosure further provide a method of quick view through selecting objects from different images.

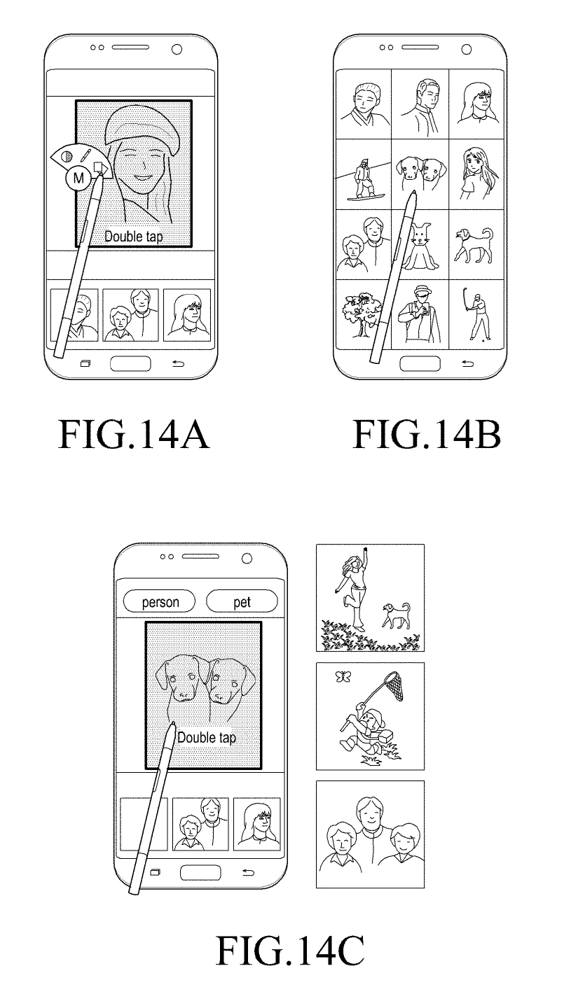

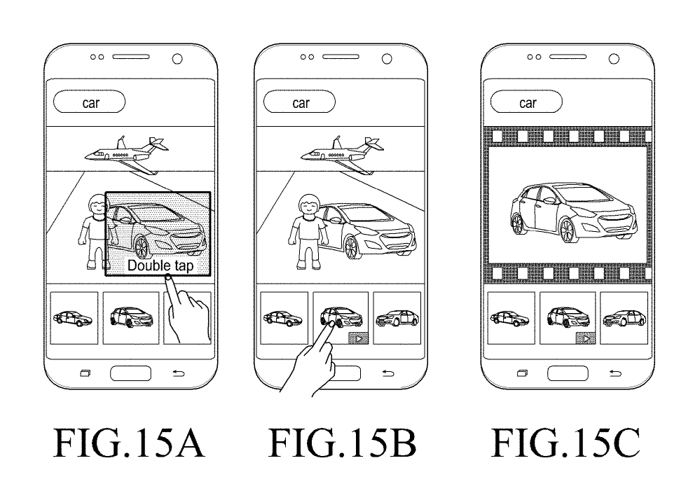

FIGS. 14A to 14C are schematic diagrams illustrating quick view based on multiple images according to various embodiments of the present disclosure.

Operation 1: The Device Detects an Operation of the User on a First Image.

As described in embodiment 1, the device detects the operation of the user on the first image. The device detects that the user selects one or more regions in the first image, determines a searching rule through detecting the user's operation, and displays the images searched out on the screen via thumbnails.

Referring to FIG. 14A, the user wants to configure that the returned images must contain person through the first image, then the user double taps an area of a person in the first image. When detecting that the user double taps the area of the person in the first image, the device determines to return images must containing person to the user.

Operation 2: The Device Searches for Images Corresponding to the User's Operation.

After detecting the user's operation on the first image, the device generates a searching rule according to the user's operation, searches for relevant images in the device or in the cloud end according to the searching rule, and displays thumbnails of the images on the screen to the user.

As shown in FIG. 14A, when detecting that the user double taps the region of person in the first image, the device determines to return images must containing person to the user.

Operation 2 is optional. It is also possible to proceed with operation 3 after operation 1.

Operation 3: The Device Detects an Operation of the User Activating to Select a Second Image.

The device detects that the user activates to select a second image, starts an album thumbnail mode for the user to select the second image. The operation of the user activating to select the second image may be a gesture, a stylus pen operation, or voice operation, etc.

For example, the user presses a button on the stylus pen. The device detects that the button of the stylus pen is pressed, pops out a menu, wherein one option in the menu is selecting another image. The device detects that the user clicks the selecting another image button. Or, the device may directly open the album in thumbnail mode for the user to select the second image.

As shown in FIG. 14A, the device detects that the button of the stylus pen is pressed, and pops out a menu for selecting another image. The device detects that the user clicks the button of selecting another image, opens the album in thumbnail mode for the user to select the second image.

For another example, the user long presses the image. The device detects the long press operation of the user, pops out a menu, wherein one option of the menu is selecting another image. The device detects that the user clicks the button of selecting another image. Or, the device directly opens the album in thumbnail mode for the user to select the second image.

For still another example, the device displays a button for selecting a second image in an image viewing mode, and detects the clicking of the button. If it is detected that the user clicks the button, images in thumbnail mode are popped out for the user to select the second image.

For yet another example, the user inputs a certain voice command, e.g., “open the album”. When detecting that the user inputs the voice command, the device opens the album in thumbnail mode for the user to select the second image.

Operation 4: The Device Detects the User's Operation on the Second Image.

The user selects the image to be operated. The device detects the image that the user wants to operate and displays the image on the screen.

The user operates on the second image. The device detects the operation of the user on the second image. As described in embodiment 1, the device detects that the user selects one or more regions in the second image, determines a searching rule according to the detected operation of the user, and displays thumbnails of found images on the screen.

Referring to FIG. 14B, the user clicks an image containing a dog. The device detects that the user clicks the image containing the dog, and displays the image containing the dog on the screen. The user wants to configure that the returned images must contain dog through the second image. Thus, the user double taps the dog region in the second image. After detecting that the user double taps the dog region in the second image, the device determines to return images must containing people and dog to the user.

Operation 5: The Device Searches for Images Corresponding to the selection operation of the user.

After detecting the operations of the user on the first image and the second image, the device generates a searching rule according to a combination of the operations on the first and second images, searches for images in the device or the cloud end according to the searching rule, and displays thumbnails of the images searched out on the screen.

Referring to FIG. 14C, the device detects that the user double taps people in the first image, double taps dog in the second image. The device determines to return images must contain both people and dog to the user, and displays thumbnails of the images on the screen.

Through this embodiment, the user is able to find the required images quickly based on ROIs in multiple images. Thus, the image searching speed is increased.

### Embodiment 3: Video Browsing Based on an Image Region

Operation 1: The Device Detects an Operation of the User on an Image.

The implementation of detecting the user's operation on the image may be seen from embodiments 1 and 2 and is not repeated herein.

The device detects that the user selects one or more ROIs in the image, determines a searching rule according to the operation of the user on the one or more ROIs, and displays thumbnails of image frames searched out on the screen.

FIGS. 15A to 15C are schematic diagrams illustrating quick browsing of a video according to various embodiments of the present disclosure.

Referring to FIGS. 15A to 15C, the user wants to configure that the returned video frames must contain a car. The user double taps the region of the car in the image. When detecting that the user double taps the region of the car in the image, the device determines to return video frames must containing a car to the user.

Besides operations to respective selectable region of the image, the device may operate video frames. When detecting that a playing video is paused, the device starts a ROI-based searching mode, such that the user is able to operate respective ROI in a frame of the paused video. When detecting that the user operates the ROI in the video frame, the device determines the searching rule.

For example, when playing a video, the device detects that the user clicks a pause button, and detects that the user double taps a car in the video frame. The device determines that the images or video frames returned to the user must contain a car.

Operation 2: The Device Searches for Video Frames Corresponding to the User′ Operation.

After detecting the operation of the user on the image or the video frame, the device generates a searching rule according to the user's operation, and searches for relevant images or video frames in the device or the cloud end according to the searching rule.

The implementation of the searching of the images is similar to embodiments 1 and 2 and is not repeated herein.

Hereinafter, the searching of the relevant video frames in the video is described.

For each video, scene segmentation is firstly performed to the video. The scene segmentation may be performed through detecting frame I during video decoding and taking frame I as a start of a scene. It is also possible to divide the video into scenes of different scenarios according to visual difference between frames, e.g., frame difference, color histogram difference, or more complicated visual characteristic (manually defined characteristic or learning-based characteristic).

For each scene, object detection is performed from the first frame, to determine whether the video frame conforms to the searching rule. If the video frame conforms to the searching rule, the thumbnail of the first video frame conforming to the searching rule is displayed on the screen.

Referring to FIG. 15A, the device detects that the user double taps a car region. The device divides the video into several scenes and detects whether there is a car in the video frames of each scene. If there is, the first video frame containing the car is returned. If there are multiple scenes including video frames containing a car, during the displaying of the thumbnail, the thumbnail of the first video frame containing the car in each scene is displayed.

Referring to FIG. 15B, the user is prompted that the thumbnail represents a video segment via an icon on the thumbnail.

Operation 3: The Video Scene Conforming to the Searching Rule is Played.

If the user wants to watch the video segment conforming to the searching rule, the user may click the thumbnail containing the video icon. When detecting that the user clicks the thumbnail containing the video icon, the device switches to the video player and starts to play the video from the video frame conforming to the searching rule of the user until a video frame not conforming to the searching rule emerges. The user may select to continue the playing of the video or return to the album to keep on browsing other video segments or images.

Referring to FIG. 15C, the user clicks the video image thumbnail containing the car. After detecting that the user clicks the thumbnail of the video frame containing the car, the device starts to play the video from this frame.

When the user wants to find a certain frame in a video, if the user knows the content of the frame, a quick search can be implemented via the method of this embodiment.

### Embodiment 4: Quick View in a Camera Preview Mode

Operation 1: The Device Detects a User's Operation in the Camera Preview Mode.

The user starts the camera and enters into the camera preview mode, and starts an image searching function. The device detects that the camera is started and the searching function is enabled. The device starts to capture image input via the camera and detects ROIs in one or more input images. The device detects operations of the user on these ROIs. The operating manner may be similar to embodiments 1, 2 and 3.

The device detects that the user selects one or more ROIs in the image and determines a search condition according to an operation of the user on the one or more ROIs.

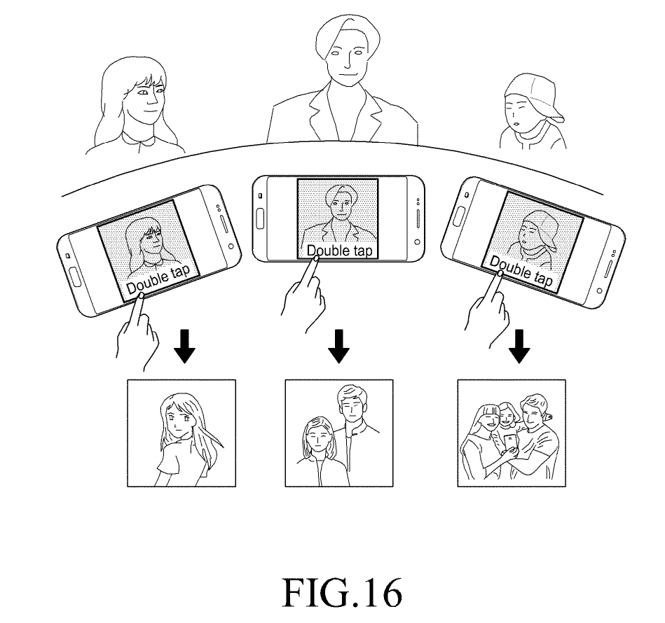

FIG. 16 is a schematic diagram illustrating quick view in the camera preview mode according to various embodiments of the present disclosure.

Referring to FIG. 16, in the preview mode, the user double taps a first person in a first scene. The device detects that the first person is double tapped in the first scene, and determines that the returned images must contain the first person. Similarly, the user double taps a second person in a second scene. The device detects that the second person is double tapped in the second scene and determines that the returned images must contain the first person and the second person. The user double taps a third person in a third scene. The device detects that the third person is double tapped in the third scene and determines that the returned images must contain the first person, the second person and the third person. The device may display thumbnails of the found images conforming to the search condition on the screen.

There may be various manners to start the search function in the camera preview mode.

For example, in the camera preview mode, a button may be configured in the user interface. The device starts the search function in the camera preview mode through detecting user's press on the button. After detecting the user's operation on a selectable region of the image, the device determines the search condition.

For another example, in the camera preview mode, a menu button may be configured in the user interface, and a button for starting the image search function is configured in this menu. The device may start the search function in the camera preview mode through detecting the user's tap on the button. After detecting an operation of the user on a selectable region of the image, the device determines the search condition.

For another example, in the camera preview mode, the device detects that the user presses a button of a stylus pen, pops out a menu, wherein a button for starting the search function is configured in the menu. The device starts the search function in the camera preview mode if detecting that the user clicks the button. After detecting the user's operation on a selectable region of the image, the device determines the search condition.

For another example, the search function of the device is started in default. After detecting the user's operation on a selectable region of the image, the device directly determines the search condition.

Operation 2: The Device Searches for Images or Video Frames Corresponding to the User's Operation.

After detecting the operation of the user in the camera preview mode, the device generates a corresponding search condition, and searches for corresponding images or video frames in the device or the cloud end according to the search condition. The search condition may be similar to that in embodiment 1 and is not repeated herein.

In this embodiment, the user may find corresponding images or video frames quickly through selecting a searching keyword in the preview mode.

### Embodiment 5: Personalized Album Tree Hierarchy

Operation 1: The Device Aggregates and Separates Images of the User.

The device aggregates and separates the images of the user according to semantics of category labels and visual similarities, aggregates semantic similar images or visually similar images, separates images with large semantic difference or large visual difference. For an image containing semantic concept, aggregation and separation is performed according to the semantic concept, e.g., scenery images are aggregated, scenery images and vehicle images are separated. For images with no semantic concept, aggregation and separation are performed based on visual information, e.g., images with red dominant color are aggregated, images with red dominant color and images with blue dominant color are separated.

As to the aggregation and separation of the images, the following manners may apply:

Manner (1), this manner is to analyze the whole image. For example, a category of the image is determined according to the whole image, or a color distribution of the whole image is determined. Images with the same category are aggregated, and images of different categories are separated. This manner is applicable for images not containing special objects.

Manner (2), this manner is to analyze the ROI of the image. For a ROI with category label, aggregation and separation may be performed according to the semantic of the category label. ROIs with the same category label may be aggregated, and ROIs with different category labels may be separated. For ROIs without category label, aggregation and separation may be performed according to visual information.

For example, color histogram may be retrieved in the ROI. ROIs with a short histogram distance may be aggregated, and ROIs with long histogram distance may be separated. This manner is applicable for images containing specific objects. In addition, in this manner, one image may be aggregated into several categories.

Manner (1) and manner (2) may be combined. For example, for scenery images, sea images with dominant color of blue may be aggregated in one category, sea images with dominant color of green may be aggregated in another category. For another example, car images of different colors may be aggregated into several categories.

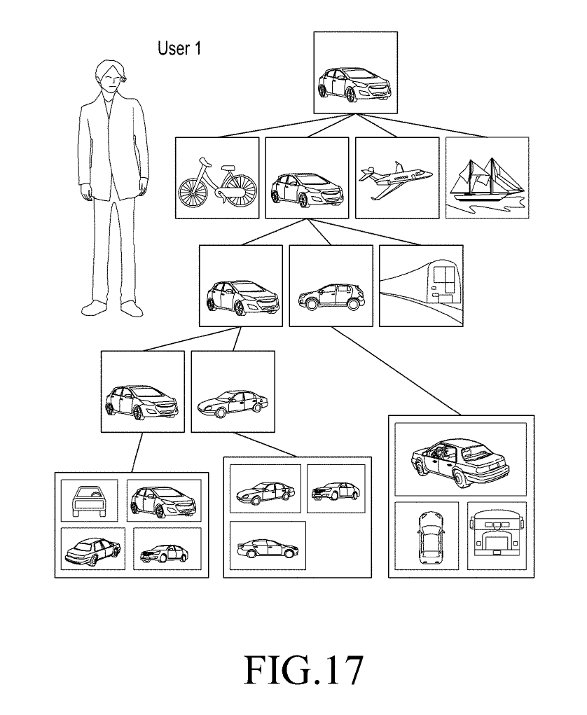

FIG. 17 is a schematic diagram illustrating a first structure of a personalized tree hierarchy according to various embodiments of the present disclosure. As shown in FIG. 17, cars are aggregated together and buses are aggregated together.

Operation 2: The Device Constructs a Tree Hierarchy for the Images after the Aggregation and Separation.

As to the ROIs or images with category labels, the tree hierarchy may be constructed according to semantic information of the category labels. The tree hierarchy may be defined offline. For example, vehicles include automobile, bicycle, motorcycle, airplane, ship, and automobile may be further divided into car, bus, truck, etc.

For ROIs or images without category label, average visual information of images aggregated together may be calculated firstly. For example, a color histogram may be calculated for each image being aggregated. Then an average value may be calculated to the histograms and is taken as the visual label of the aggregated images. For each aggregation set without category label, a visual label is calculated and a distance between visual labels is calculated. Visual labels with short distance are abstracted into a higher layer visual label. For example, during the aggregation and separation, images with dominant color of blue are aggregated into a first aggregation set, images with dominant color of yellow are aggregated into a second aggregation set, and images with dominant color of red are aggregated into a third aggregation set. The distance between the visual labels of the three aggregation sets are calculated. Since yellow includes blue information, the yellow visual label and the blue visual label are abstracted into one category.

Operation 3: The Device Modifies the Tree Hierarchy.

Firstly, number of images in each layer is determined. If the number of images exceeds a predefined threshold, labels of a next layer are exposed to users.

For example, suppose that the predefined threshold for the number of images in one layer is 20. There are 50 images in the scenery label. Therefore, the labels such as sea, mountain and desert are created.

The device may configure a category to be displayed compulsively according to user's manual configuration. For example, suppose that the predefined threshold for the number of images in one layer is 20, and there are 15 images in the label of scenery. The device detects that the user manually configures to individually display the sea images. Thus, the label of sea is shown and other scenery labels are shown as one category.

For different users, images may distribute differently in their devices. Therefore, the tree hierarchies shown by the devices may also be different.

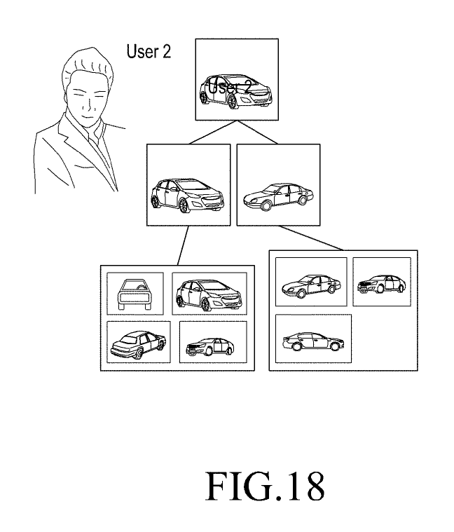

FIG. 18 is a schematic diagram of a second personalized tree hierarchy according to various embodiments of the present disclosure.

Referring to FIG. 17, under the vehicle label of user 1, there are four categories including bicycle, automobile, airplane and ship, wherein automobile further includes car, bus and tramcar, and car and bus may be further classified according to colors.

However, in FIG. 18, in the vehicle label of user 2, there are merely cars in different colors.

### Embodiment 6: Personalized Image Category Definition and Classification

Embodiment 6 is able to realize personalized category definition for images in the album according to user's operation and may realize classification of images into the personalized category.

Operation 1: The Device Determines Whether the Label of an Image should be Modified.

The device determines whether the user manually modifies in an attribute management interface of the image. If yes, the device creates a new category used for the image classification. For example, the user modifies the label of an image of a painting from “paintings” to “my paintings” when browsing images. The device detects the modification of the user to the image attribute, and determines that the label of the image should be modified.

The device determines whether the user has made a special operation when managing the image. If yes, the device creates a new category for image classification. For example, the user creates a new folder when managing images, and names the folder as “my paintings” and moves a set of images into this folder. The device detects that a new folder is created and there are images moved into the folder, and determines that the label of the set of images should be modified.

The device determines whether the user has shared an image when using a social application. In a family group, images relevant to family members may be shared. In a pet-sitting exchange group, images relevant to pets may be shared. In a reading group, images about books may be shared. The device associates images in the album with the social relationship through analyzing the operation of the user, and determines that the label of the image should be modified.

Operation 2: A Personalized Category is Generated.

When determining that the label of the image should be modified, the device generates a new category definition. The category is assigned with a unique identifier. Images with the same unique identifier belong to the same category. For example, the images of paintings in operation 1 are assigned with the same unique identifier, “my paintings”. Images shared in the family group are assigned with the same unique identifier “family group” Similarly, images shared with respective other groups are assigned with a unique identifier, e.g., “pet” or “reading”.

Operation 3: A Difference Degree of the Personalized Category is Determined.

The device analyzes the name of the personalized category and determines the difference degree of the name compared to preconfigured categories, so as to determine the manner for implementing the personalized category.

For example, the name of a personalized category is “white pet”. The device analyzes that the category consists of two elements, one is a color attribute “white” and the other is object type “pet”. The device has preconfigured sub-categories “white” and “pet”. Therefore, the device associates these two sub-categories. All images classified into “white” and are “pet” are re-classified into “white pet”. Thus, the personalized category classification is realized.

If the preconfigured sub-categories in the device do not include “white” and “pet”, it is required to train a model. For example, the device uploads “white pet” images collected by the user to the cloud end. The cloud server adds a new category on the original model, and trains according to the uploaded images. After the training is finished, the updated model is returned to the user device. When a new image appears in the user's album, the updated model is utilized to categorize the image. If the confidence score that the image belongs to “white pet” category exceeds a threshold, the image is classified into the “white pet” category.

Operation 4: The Device Determines Classification Consistency Between the Device and the Cloud End.

When the classification results of one image are different in the cloud end and the device, the result needs to be optimized. For example, for an image of “dog”, the classification result of the device is “cat” and the classification result of the cloud end is “dog”.

In the case that the device does not detect the user's feedback: suppose that the threshold is configured to 0.9, if the classification confidence score of the cloud end is higher than 0.9, and the classification confidence score of the device is lower than 0.9, it is regarded that the image should be labeled as “dog”. On the contrary, if the classification confidence score of the cloud end is lower than 0.9 and the classification confidence score of the device is higher than 0.9, the image should be labeled as “cat”. If the classification confidence scores of both the cloud end and the device are lower than 0.9, the category of the image should be raised by one layer and labeled as “pet”.

In the case that the device detects the user's positive feedback: an erroneous classification result is uploaded to the cloud end, including the erroneously classified image, the category in which the image is classified and the correct category designated by the user, and model training is started. After the training, the new model is provided to the device for update.

### Embodiment 7: Quick View on the Device

Embodiment 7 is able to implement quick view based on the tree hierarchy of embodiment 5.

Operation 1: The Device Displays Label Categories of a Certain Layer.

When the user browses a certain layer, the device detects that the user is browsing the layer and displays all label categories contained in this layer to the user, in a manner of text or image thumbnail. When the image thumbnails are displayed, preconfigured icons for the categories may be displayed, or real images in the album may be displayed. It is possible to select to display the thumbnails of images which was most recently modified, or select to display the thumbnails of images with highest confidence scores in the categories.

Operation 2: The Device Detects the User's Operation and Provides a Feedback.

The user may operate on each label category so as to enter into a next layer.

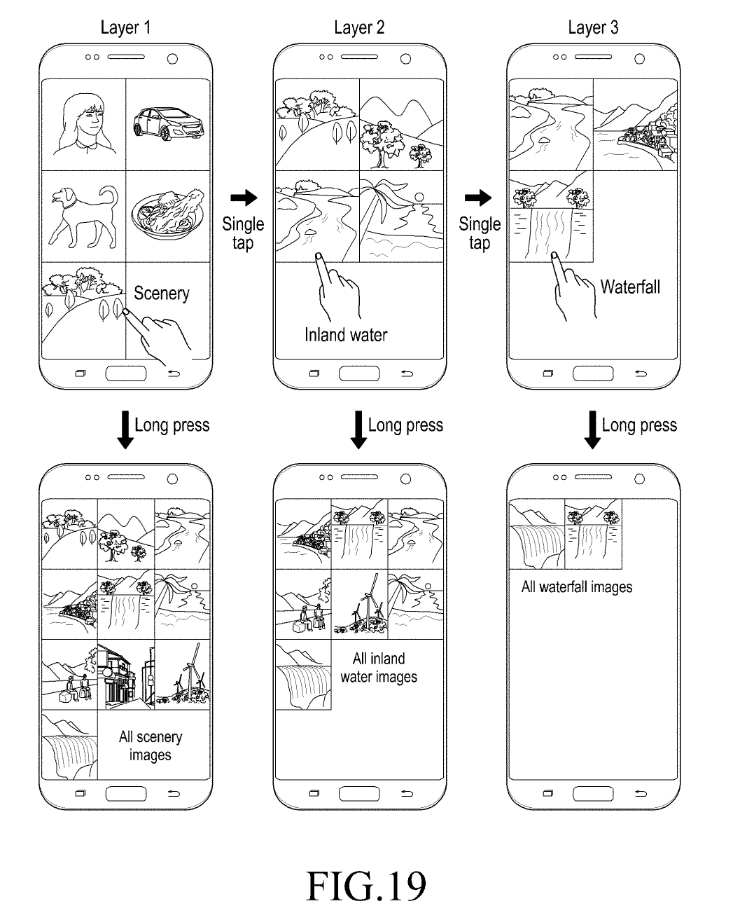

FIG. 19 is a schematic diagram illustrating a quick view of the tree hierarchy on a mobile terminal according to various embodiments of the present disclosure.

Referring to FIG. 19, when the user single taps a label, the device detects that a label is single tapped and displays the next layer of the label. For example, the user single taps the scenery label. The device detects that the scenery label is single tapped, and displays labels under the scenery label including sea, mountain, inland water, desert to the user. If the user further single taps the inland water, the device detects that the inland water label is single tapped, and displays labels under this label to the user, including waterfall, river, and lake.

The user may operate on each label category, to view all images contained in the label category.

As shown in FIG. 19, the user long presses a label. The device detects that the label is long pressed, and displays all images of the label. When the user long presses the scenery label, the device detects that the user long presses the scenery label and displays all image labeled as scenery to the user, including sea, mountain, inland water and desert. When the user long presses the inland water label, the device detects that the user long presses the inland water label and displays all images labeled as inland water to the user, including waterfall, lake and river. When the user long presses the waterfall, the device detects that the waterfall label is long pressed and displays all waterfall images to the user.

The user may also operate via a voice manner. For example, the user inputs “enter inland water” via voice. The device detects the user's voice input “enter inland water”, determines according to natural language processing that the user's operation is “enter” and an operating object is “inland water”. The device displays labels under the inland water label to the user, including waterfall, river and lake. If the user inputs “view inland water” via voice, the device detects the voice input “view inland water”, and determines according to the natural language processing that the operation is “view” and the operating object is “inland water”. The device displays all images labeled as inland water to the user, including images of waterfall, lake and river.

In this embodiment, through classifying the images through a visualized thumbnail manner, the user is able to find an image quickly according to the category. Thus, the viewing and searching speed is increased.

### Embodiment 8: Quick View on a Small Screen

Some electronic devices have very small screens. Embodiment 8 provides a solution as follows.

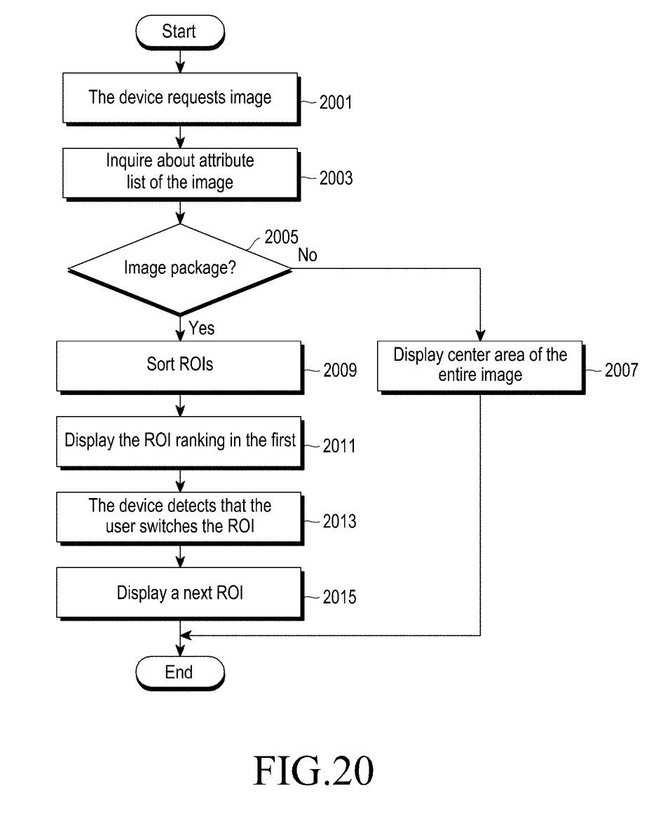

FIG. 20 is a flowchart illustrating quick viewing of the tree hierarchy on a small screen device according to various embodiments of the present disclosure. The small screen device requests an image at operation 2001, and inquires about the attribute list of the image at operation 2003. If the attribute list of the image includes at least one ROI at operation 2005, the ROIs are sorted at operation 2009. The sorting method may be seen in the foregoing quick viewing and searching. The ROI ranking in the first is displayed on the screen at operation 2011. If the device detects a displaying area switching operation of the user at operation 2013, the next ROI is displayed at operation 2015. If there is no ROI in the attribute list, the central part of the image is displayed at operation 2007.

Specifically, embodiment 8 may be implemented based on the tree hierarchy of embodiment 5.

Operation 1: The Device Displays a Label Category of a Certain Layer.

When the user browses a certain layer, the device detects that the user is browsing the layer and displays some label categories of the layer to the user, in a manner of text or image thumbnail. When image thumbnails are displayed, a preconfigured icon for a category may be displayed, or a real image in the album may be displayed. It is possible to select to display the thumbnail of an image which is most recently modified, or select to display the thumbnail of an image with the highest confidence score in the category, etc.

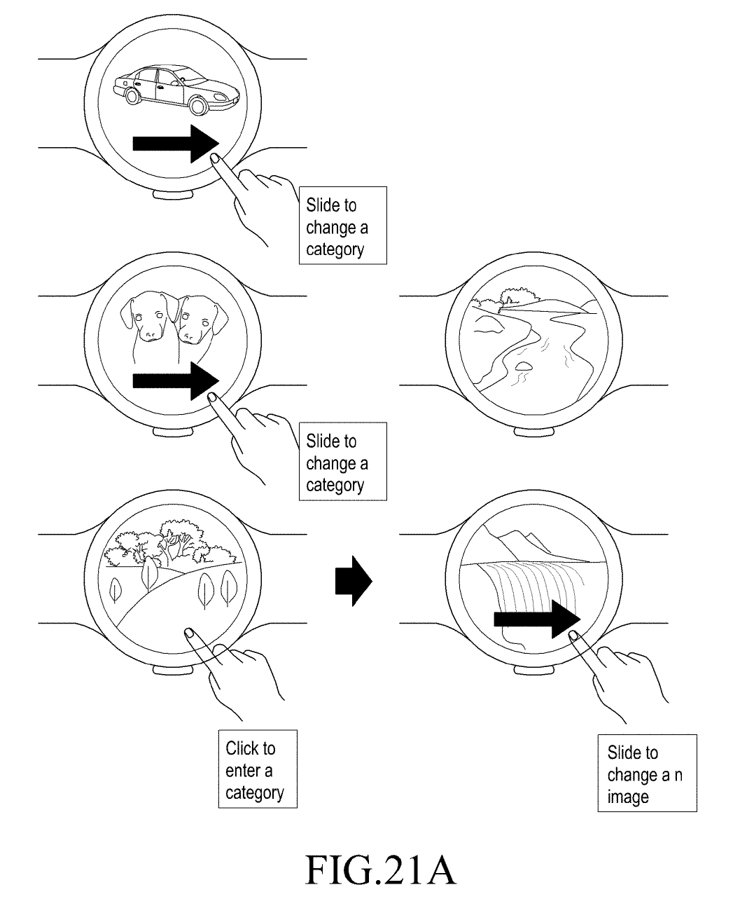

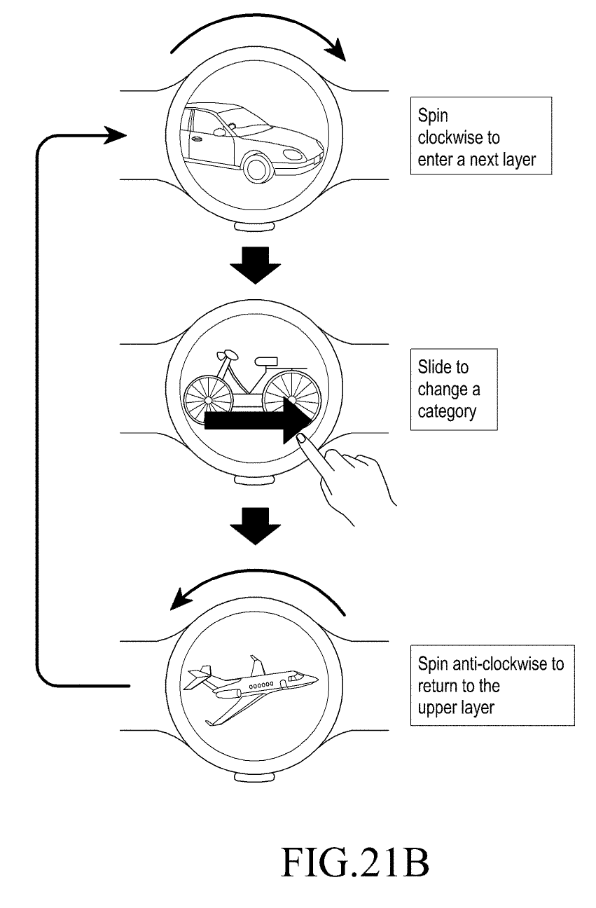

FIGS. 21A and 21B are schematic diagrams illustrating quick view of the tree hierarchy on a small screen according to various embodiments of the present disclosure.

Referring to FIG. 21A, when the user browses a layer consisting of vehicle, pet and scenery, the device detects that the layer is browsed, and displays the thumbnail of one of the categories on the screen each time, e.g., vehicle, pet or scenery.

Operation 2: The Device Detects the User's Operation and Provides a Feedback.

The user may operate on each label category, so as to switch between different label categories. As shown in FIG. 21A, the device initially displays the label of the vehicle category. The user slides finger on the screen. The device detects the sliding operation of the user on the screen, and switches from the label of the vehicle category to the label of the pet category. When detecting the sliding operation of the user next time, the device switches from the pet category to the scenery category.

It should be noted that, other manners may be adopted to perform the label switching. The above is merely an example.

The user may operate each label category to view all images contained in the label category. During the display, merely some images are displayed each time, and the user may control to display other images.

As shown in FIG. 21A, when the user single taps a label, the device detects that a label is single tapped and displays one of the images under this label. For example, the user single taps the scenery label. The device detects that the scenery label is single tapped and displays an image containing desert scene under the scenery label to the user. When detecting a slide operation of the user, the device displays another image under the scenery label.

It should be noted that, other operations may be adopted to switch images. The above is merely an example.

The user may operate on each layer to switch between layers. When detecting a first kind of operation of the user, the device enters into a next layer. When detecting a second kind of operation of the user, the device returns to the upper layer.

Referring to FIG. 21B, the device displays the layer of scenery and vehicle. When the device displays the label of vehicle, the user spins the dial clockwise. The device detects that the dial is spun clockwise and enters into the next layer from the layer of scenery and vehicle, the next layer includes labels of airplane, bicycle, etc. The user may switch to another label category via a sliding operation, e.g., switching from bicycle to airplane. When the user spins the dial anti-clockwise, the device detects the anti-clockwise spinning of the dial, and switches to the upper layer from the layer of bicycle and airplane, the upper layer includes labels of scenery and vehicle, etc. It should be noted that, other operations may be adopted to switch layers. The above is merely an example.

Similarly, the user may also implement the above via voice. For example, the user inputs “enter inland water” via voice. The device detects the voice input “enter inland water”, determines according to natural language processing that the user's operation is “enter” and the operating object is “inland water”, and displays labels of waterfall, river and lake under the inland water label to the user. If the user inputs “view inland water” via voice, the device detects the user's voice input “view inland water”, determines according to the natural language processing that the user's operation is “view” and the operating object is “inland water”, and displays all images labeled as inland water to the user, including images of waterfall, lake and river. For another example, the user inputs “return to the upper layer” via voice. The device detects the user's voice input “return to the upper layer” and switches to the upper layer.

It should be noted that, the above voice input may also have other contents. The above is merely an example.

### Embodiment 9: Image Display on Small Screen

Some electronic devices have small screens. The user may view images of other devices or the cloud end using these devices. In order to implement quick view on such electronic devices, embodiments of the present disclosure provide a following solution.

Operation 1: The Device Determines the Number of ROIs in the Image to be Displayed.

The device checks the number of ROIs included in the image according to a region list of the image, and selects different displaying manners with respect to different numbers of ROIs.

Operation 2: The Device Determines the Displaying Manner According to the Number of ROIs in the Image.

The device detects the number of ROIs in the image, and selects different displaying manners for different numbers of ROIs.

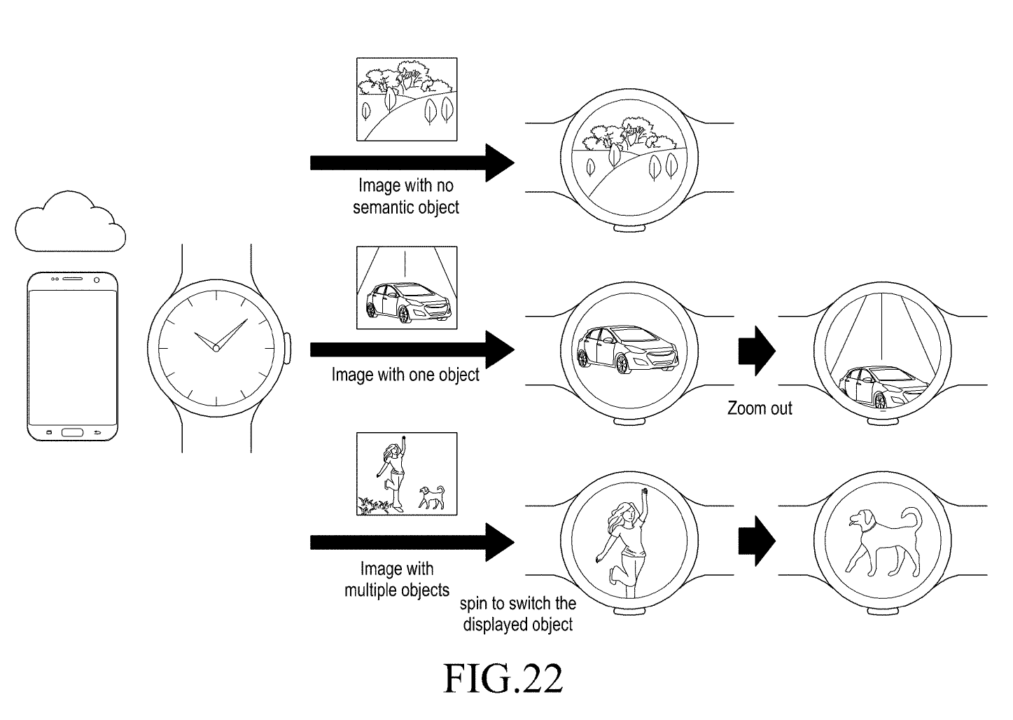

FIG. 22 is a schematic diagram illustrating display of an image on a small screen device according to embodiments of the present disclosure.

Referring to FIG. 22, if the device detects that a scenery image does not contain any ROI, the device displays a thumbnail of the whole image on the screen. Considering difference between screens, a portion may be cut from the original image when necessary, e.g., if the screen is round, an inscribed circle may be cut from the center of the image.

If the device detects that the image contains a ROI, the device selects one ROI and displays the ROI in the center of the screen. The selection may be performed according to the user's gaze heat map. The ROI that the user pays most attention to may be displayed preferably. The selection may also be performed according to the category confidence score of the region. The ROI with the highest confidence score may be displayed preferably.

Operation 3: The Device Detects the Different Operations of the User and Provides a Feedback.

The user performs different operations on the device. The device detects the different operations, and provides different feedbacks according to the different operations. The operations enable the user to zoom in, zoom out the image. If the image contains multiple ROIs, the user may switch between the ROIs via some operations.

For example, if the user's fingers pinch the screen, the device detects that the user's fingers pinch, and zooms out the image displayed on the screen, until the long side of the image is equal to the short side of the device.

For example, if the user's fingers spread the screen, the device detects that the user's fingers spread, and zooms in the image displayed on the screen, until the image is enlarged to a certain times of the original image. The times may be defined in advance.

For another example, as shown in FIG. 22, when the user spins the dial, the device detects that the dial is spun, and different ROIs are displayed in the middle of the screen. When the user spins the dial clockwise, the device detects that the dial is spun clockwise, and a next ROI is displayed in the middle of the screen. If the user spins the dial anti-clockwise, the device detects that the dial is spun anti-clockwise, and displays a previous ROI in the middle of the screen.

Through this embodiment, the user is able to view images conveniently on a small screen device.

### Embodiment 10: Image Transmission (1) Based on ROI

At present, more and more people store images at the cloud end. This embodiment provides a method for viewing images in the cloud end on a device.

Operation 1: The Device Determines a Transmission Mode According to a Rule.

The device may determine to select a transmission mode according to the environment or condition of the device. The environment or condition may include the number of images requested by the device from the cloud end or another device.

The transmission mode mainly includes two kinds: one is complete transmission, and the other is adaptive transmission. The complete transmission mode transmits all data to the device without compression. The adaptive transmission mode may save bandwidth and power consumption through data compression and multiple times of transmission.

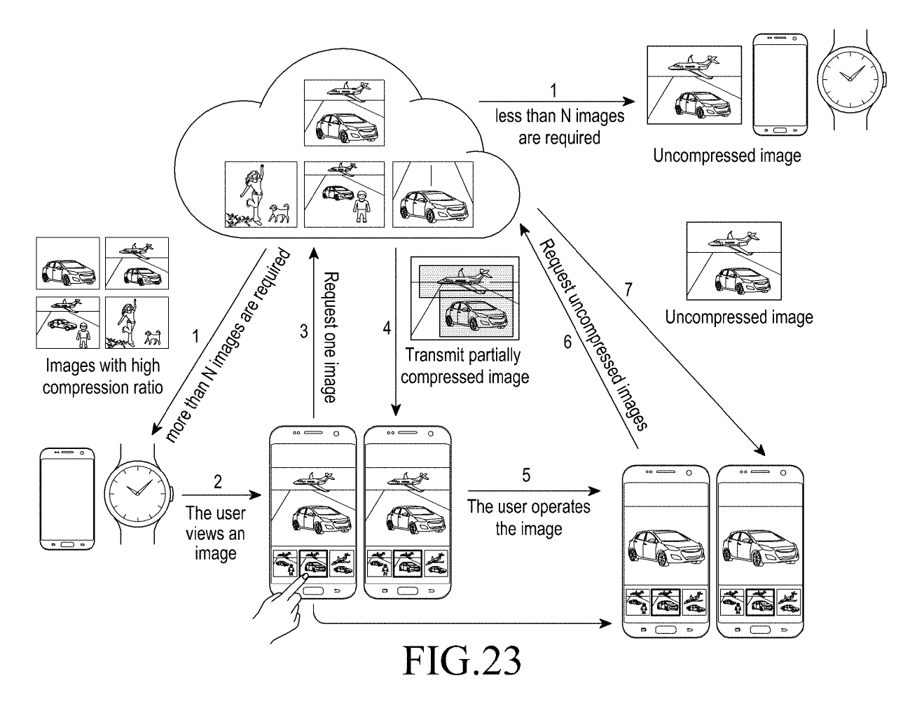

FIG. 23 is a schematic diagram illustrating transmission modes for different amounts of transmission according to various embodiments of the present disclosure.

Referring to FIG. 23, during the image transmission, a threshold N may be configured in advance. N may be a predefined value, e.g., 10. The value of N may also be calculated according to image size and the number of requested images. N is a maximum value that meets: the traffic for completely transmitting N images one time is lower than that for adaptively transmitting the N images.

If the device detects that less than N images are requested by the user, the complete transmission mode is adopted to transmit the images. If the device detects that more than N images are requested by the user, the adaptive transmission mode is adopted to transmit the images.

Operation 2: Images are Transmitted Via the Complete Transmission Mode.

If the device detects that the number of images requested by the user is smaller than N, the images are transmitted using the complete transmission mode. At this time, no compression or processing is performed to the images to be transmitted. The original images are transmitted to the requesting device completely through the network.

Operation 3: Images are Transmitted Via the Adaptive Transmission Mode.

In the adaptive transmission mode, a whole image compression is performed to the N images at the cloud end or other device to reduce the amount of data to be transmitted, e.g., compress the image size or select a compression algorithm with higher compression ratio. The N compressed images are transmitted to the requesting device via a network connection for the user's preview.

If the user selects to view some or all of the N images, the device detects that an image A is displayed in full-screen view, the device requests partially compressed image from the cloud end or another device. After receiving the request of the partially compressed image A, the cloud end or the other device compresses the original image A according to a rule that the ROI is compressed with a low compression ratio and background other than the ROI is compressed with a high compression ratio. The cloud end or the other device transmits the partially compressed image to the device.

As shown in FIG. 23, the ROIs of the image requested by the user include an airplane and a car. The regions of the airplane and the car are compressed with a low compression ratio. Thus, the user is able to view details of the airplane and the car clearly. Regions other than the airplane and the car are compressed with a high compression ratio, so as to save traffic.

When the user further operates the image, e.g., edit, zoom in, share, or directly request the original image, the device requests the un-compressed original image from the cloud end or the other device. After receiving the request of the device, the cloud end or the other device transmits the un-compressed original image to the device.

Through this embodiment, the amount of transmission of the device may be restricted within a certain range and the data transmission amount may be reduced. Also, if there are too many images to be transmitted, the quality of the images may be decreased, so as to enable the user to view the required image quickly.

### Embodiment 11: Image Transmission (2) Based on ROI

At present, more and more people store images in the cloud end. This embodiment provides a method for viewing cloud end images on a device.

Operation 1: The Device Determines a Transmission Mode According to a Rule.

The device may select a transmission mode according to the environment or condition of the device. The environment or condition may be a network connection type of the device, e.g., Wi-Fi network, operator's communication network, wired network, etc., network quality of the device (e.g., high speed network, low speed network, etc.), required image quality manually configured by user, etc.

The transmission mode mainly includes three types: the first is complete transmission, the second is partially compressed transmission, and the third is completely compressed transmission. The complete transmission mode transmits all data to the device without compression. The partially compressed transmission mode partially compresses data before transmitting to the device. The completely compressed transmission mode completely compresses the data before transmitting to the device.

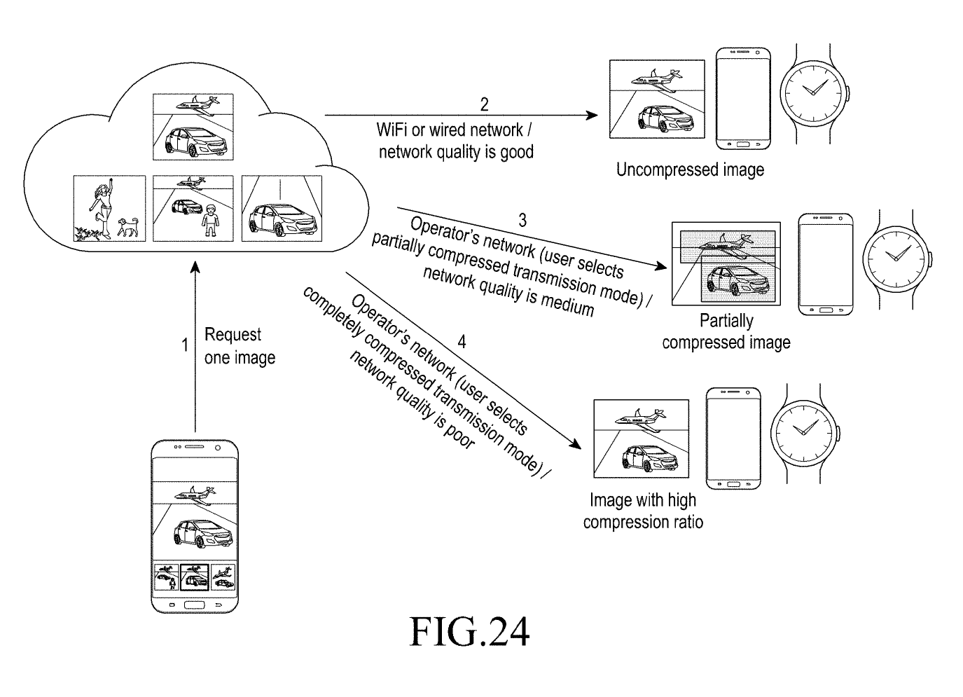

FIG. 24 is a schematic diagram illustrating transmission modes under different network scenarios according to various embodiments of the present disclosure.

Referring to FIG. 24, if the device is in a Wi-Fi network or a wired network, data transmission fees is not considered. If the device detects that the user requests images, the device transmits the images via the complete transmission mode.

As shown in FIG. 24, if the device is in an operator's network, data transmission fees need to be considered. When detecting that the user requests images, the device may transmit the images to the device via the complete transmission mode, or the partially compressed transmission mode, or the completely compressed transmission mode. The selection may be implemented according to a preconfigured default transmission mode, or a user selected transmission mode. Through this embodiment, the data transmission amount may be reduced when the user is in the operator's network.

The device may further determine to select a transmission mode according to the network quality. For example, the complete transmission mode may be selected if the network quality is good. The partially compressed transmission may be selected if the network quality is moderate. The completely compressed transmission mode may be selected if the network quality is poor. Through this embodiment, the user is able to view required images quickly.

Operation 2: Images are Transmitted Via the Complete Transmission Mode.

When transmitting images via the complete transmission mode, the cloud device does not compress or process the images to be transmitted, and transmits the images to the user device via the network completely.

Operation 3: Images are Transmitted Via the Partially Compressed Transmission Mode.

When images are transmitted via the partially compressed transmission mode, the user device requests partially compressed images from the cloud end or another device. After receiving the request, the cloud end or the other device compresses the images according to a rule that ROI of the image is compressed with a low compression ratio and the background other than the ROI is compressed with a high compression ratio. The cloud end or the other device transmits the partially compressed images to the user device via the network.

As shown in FIG. 24, the ROIs of the images requested by the user include an airplane and a car. Thus, the regions of the airplane and the car are compressed with a low compression ratio, such that the user is able to view the details of the airplane and the car clearly. Regions other than the airplane and the car are compressed with a high compression ratio, so as to save traffic.

Operation 4: Images are Transmitted Via the Completely Compressed Transmission Mode.

A full image compression is firstly performed to the requested images at the cloud end or another device, so as to reduce the amount of data to be transmitted, e.g., compress image size or select a compression algorithm with a higher compression ratio. The compressed images are transmitted to the requesting device via the network for the user's preview.

Based on the transmission mode determined in 1, operations 2, 3 and 4 may be performed selectively.

### Embodiment 12: Quick Sharing in the Thumbnail View Mode

The determination of the images to be shared may be implemented by the device automatically or by the user manually.

If the device determines the images to be shared automatically, the device determines the sharing candidate images through analyzing contents of the images. The device detects the category label of each ROI of the images, puts images with the same category label into one candidate set, e.g., puts all images containing pets into one candidate set.

The device may determine the sharing candidate set based on contacts emerge in the images. The device detects the identity of each person in each ROI with category label of people, and determines images of the same contact or the same contact group as one candidate set.

The device may also determine a time period, and determines images shot within the time period as sharing candidates. The time period may be configured according to the analysis of information such as shooting time, geographic location. The time period may be defined in advance, e.g., every 24 hours may be configured as one time period. Images shot within each 24 hours are determined as one sharing candidate set.

The time period may also be determined according to variation of geographic locations. The device detects that the device is at a first geographic location at a first time instance, a second geographic location at a second time instance, and a third geographic location at third time instance. The first geographic location and the third geographic location are the same. Thus, the device configures that the time period is from the second time instance to the third time instance. For example, the device detects that the device is in Beijing on 1st day of a month, in Nanjing on 2nd day of the month, and in Beijing on 3rd day of the month. Then, the device configures the time period as from the 2nd day to the 3rd day. Images shot from the 2nd day to the 3rd day are determined as a sharing candidate set. When determining whether the geographic location of the device is changed, the device may detect the distance between respective geographic locations. For example, after moving for a certain distance, the device determines that the geographic location has changed. The distance may be defined in advance, e.g., 20 kilometers.

If the user manually selects the sharing candidate images, the user operates on the thumbnails to select the images to be shared, e.g., long pressing the image. After detecting the user's operation, the device adds the operated image to the sharing candidate set.

Operation 2: The Device Prompts the User to Share the Image in the Thumbnail View Mode.

When detecting that the device is in the thumbnail view mode, the device prompts the user of the sharing candidate set via some manners. For example, the device may frame thumbnails of images in the same candidate set with the same color. A sharing button may be displayed on the candidate set. When the user clicks the sharing button, the device detects that the sharing button is clicked and starts the sharing mode.

Operation 3: Share the Sharing Candidate Set.

The sharing candidate set may be shared with another contact individually. The device shares images containing a contact with the contact. The device firstly determines each image in the sharing candidate set contains which contacts and then respectively transmits the images to the corresponding contacts.

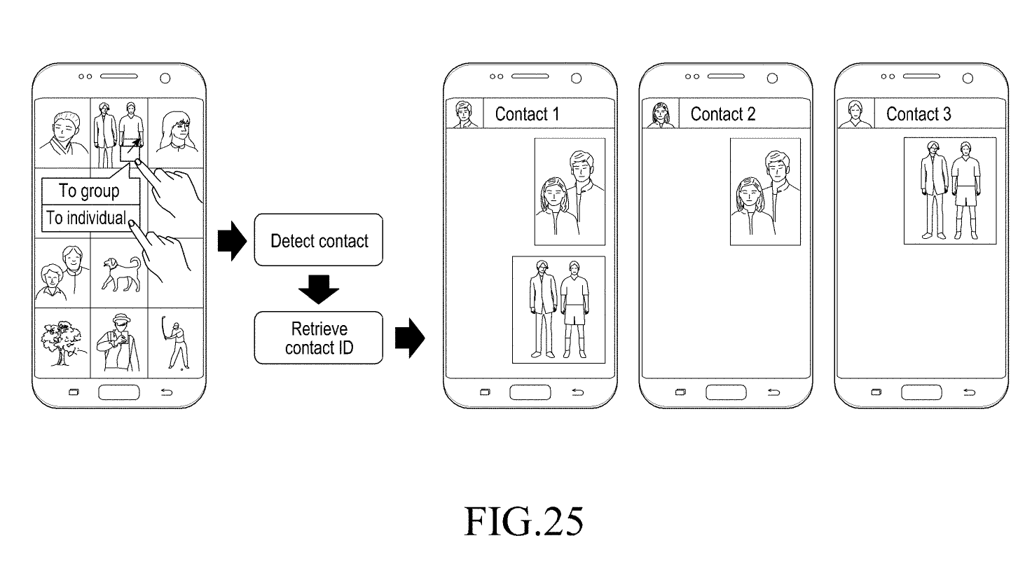

FIG. 25 is a first schematic diagram illustrating image sharing on the thumbnail view interface according to various embodiments of the present disclosure.

Referring to FIG. 25, the device determines image 1 and image 2 as one candidate sharing set, and detects that image 1 contains contacts 1 and 2, and image 2 contains contacts 1 and 3.

When the user clicks to share to respective contacts, the device transmits images 1 and 2 to contact 1, transmits image 1 to contact 2, and transmits image 2 to contact 3. Thus, the user does not need to perform repeated operations to transmit the same image to different users.

The candidate sharing set may also be shared to a contact group in batch. The device shares the images containing respective contacts to a group containing the contacts. The device firstly determines the contacts contained in each image of the sharing candidate set, and determines whether there is a contact group which includes exactly the same contacts as the sharing candidate set. If yes, the images of the sharing candidate set are shared to the contact group automatically, or after the user manually modifies the contacts. If the device does not find a contact group completely the same as the sharing candidate set, the device creates a new contact group containing the contacts in the sharing candidate set, provides the contact group to the user as a reference. The user may modify the contacts in the group manually. After creating the new contact group, the device transmits the images in the sharing candidate set to the contact group.

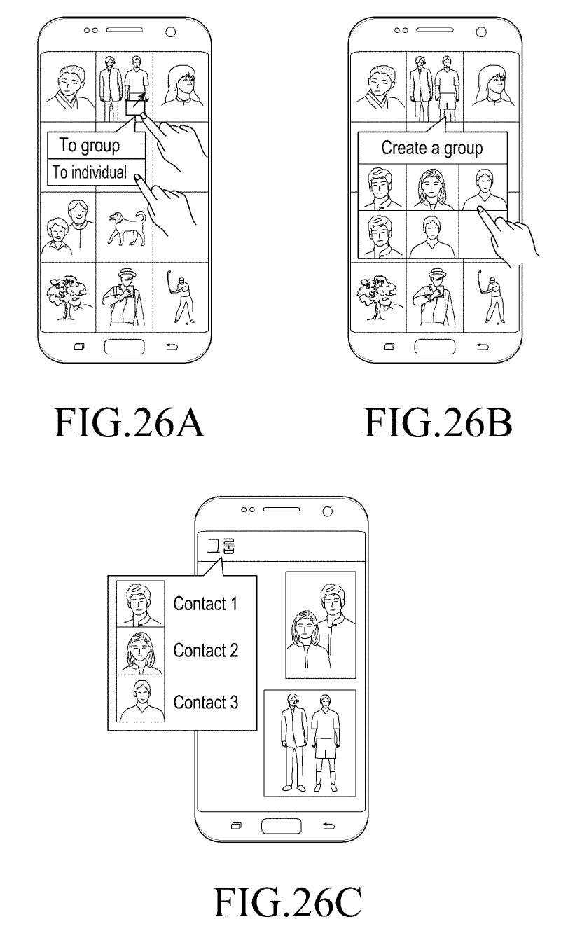

FIGS. 26A to 26C are second schematic diagrams illustrating image sharing on the thumbnail view interface according to various embodiments of the present disclosure.

Referring to FIG. 26A, the device determines images 1 and 2 as one candidate sharing set, and detects that image 1 includes contacts 1 and 2, image 2 includes contacts 1 and 3. As shown in FIG. 26B, when the user clicks to share to a contact group, the device detects that there is a contact group includes and merely includes contacts 1, 2, 3. As shown in FIG. 26C, the device transmits images 1 and 2 to the contact group.

Operation 4: Modify the Sharing State of the Sharing Candidate Set.

After the images in the sharing candidate set are shared, the device prompts the user of the shared state of the sharing candidate set via some manners, e.g., inform the user via an icon that that sharing candidate set has been shared with an individual contact, a contact group, number of shared times, etc.

Through this embodiment, image sharing efficiency is improved.

### Embodiment 13: Quick Sharing in Chat Mode

Operation 1: The Device Generates a Sharing Candidate Set.

Similar as embodiment 11, the device may determine the sharing candidate set through analyzing information such as image contents, shooting time, geographic location. This is not repeated in embodiment 13.

Operation 2: The Device Prompts the User to Share the Images in the Chat Mode.

When detecting that the device is in the chat mode, the device retrieves the contact chatting with the user, compares the contact with each sharing candidate set. If a sharing candidate set includes a contact consistent with the contact chatting with the user, and the sharing candidate set has not been shared before, the device prompts the user to share via some manners.

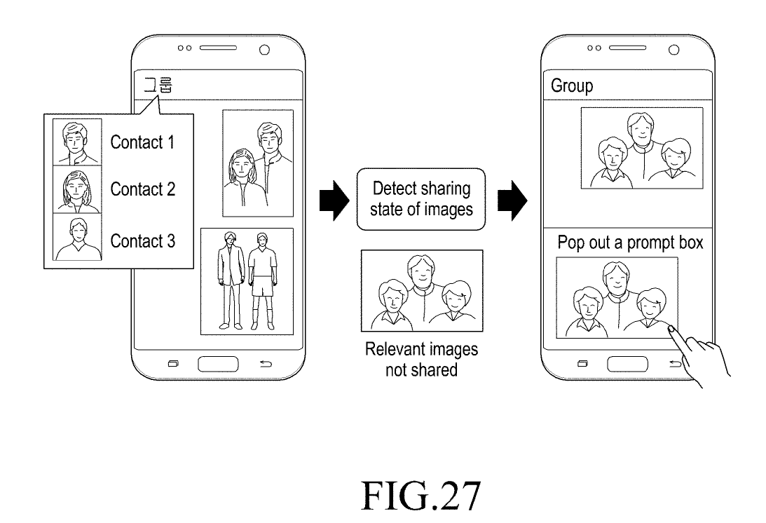

FIG. 27 is a schematic diagram illustrating a first sharing manner on the chat interface according to various embodiments of the present disclosure.

Referring to FIG. 27, when detecting that the user is chatting with a contact group including contacts 1, 2, 3, the device finds that there is a sharing candidate set including contacts 1, 2, 3. The device pops out a prompt box and displays thumbnails of the images in the sharing candidate set. When detecting the user clicks a share button, the device transmits the images in the sharing candidate set to the current group chat.

When detecting that it is in the chat mode, the device may analyze the user's input, determines whether the user intents to share image via natural language processing. If the user intents to share image, the device analyzes the content that the user wants to share, pops out a box, displays ROIs with label categories consistent with the content that the user wants to share. The ROIs may be arranged according to a time order, user's browsing frequency, etc. When detecting that the user selects one or more images and clicks to transmit, the device transmits the image containing the ROI to the group or crops the ROI and transmits the ROI to the group.

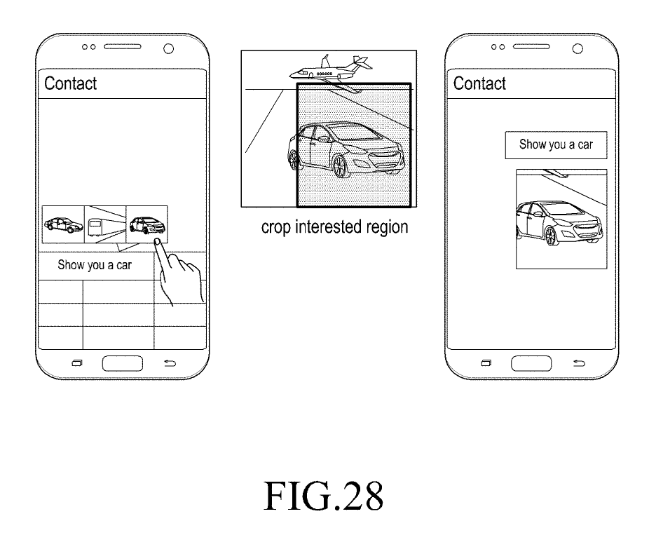

FIG. 28 is a schematic diagram illustrating a second sharing manner on the chat interface according to various embodiments of the present disclosure. As shown in FIG. 28, the user inputs “show you a car”. The device detects the user's input, and determines that the user intents to share the label category of car. The device pops out a box, displays ROIs with label category of car. When detecting that the user clicks one of the images, the device transmits the cropped ROI to the group.

Through this embodiment, the image sharing efficiency is increased.

### Embodiment 14: Image Selection Method Based on ROI

Operation 1: The Device Aggregates and Separates ROIs within a Time Period.

The device determines a time period, aggregates and separates the ROIs within this time period.

The time period may be defined in advance, e.g., every 24 hours is a time period. The images shot within each 24 hour are defined as an aggregation and separation candidate set.

The time period may be determined according to the variation of geographic location. The device detects that the device is at a first geographic location at a first time instance, a second geographic location at a second time instance, and a third geographic location at third time instance. The first geographic location and the third geographic location are the same. Thus, the device configures that the time period is from the second time instance to the third time instance. For example, the device detects that the device is in Beijing on 1st day of a month, in Nanjing on 2nd day of the month, and in Beijing on 3rd day of the month. Then, the device configures the time period as from the 2nd day to the 3rd day. Images shot from the 2nd day to the 3rd day are determined as a sharing candidate set. When determining whether the geographic location of the device is changed, the device may detect the distance between respective geographic locations. For example, after moving for a certain distance, the device determines that the geographic location has changed. The distance may be defined in advance, e.g., 20 kilometers.

The device aggregates and separates the ROIs through analyzing contents of images within a time period. The device detects the category labels of the ROIs of the images, aggregates the ROIs with the same label category, and separates the ROIs with different category labels, e.g., respectively aggregates images of food, contact 1, contact 2.

The device may aggregates and separates ROIs according to contacts emerge in the images. The device may detect the identity of each person in ROIs with the category label of people, and aggregates images of the same contact, separates images of different contacts.

Operation 2: The Device Generates a Selected Set.

Manner (1): Selecting Procedure from Image to Text.

The device selects ROIs in respective aggregation sets. The selection may be performed according to a predefined rule, e.g., most recent shooting time, earliest shooting time. It is also possible to sort the images according to qualities and select ROI with the highest image quality. The selected ROIs are combined. During the combination, shape and proportion of a combination template may be adjusted automatically according to the ROIs. The image tapestry may link to the original images in the album. Finally, a simple description to the image tapestry may be generated according to the contents of the ROIs.

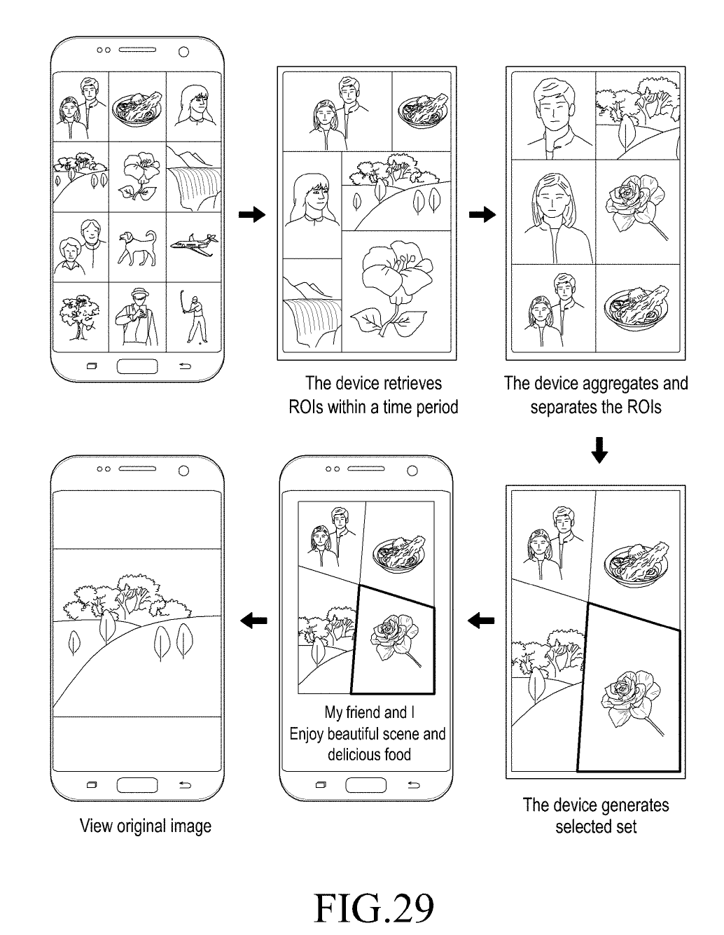

FIG. 29 is a schematic diagram illustrating image selection from image to text according to various embodiments of the present disclosure.

Referring to FIG. 29, the device firstly selects images within one day, aggregates and separates the ROIs of the images to generate a scenery aggregation set, a contact 1 aggregation set, a contact 2 aggregation set, a food aggregation set and a flower aggregation set. Then, the device selects four images from them for combination. During the combination, the main body of the ROI is shown. Finally, a paragraph of text is generated according to the contents of the ROIs. The device detects that the user clicks the image tapestry, and may link to the original image where the ROI is located.

Manner (2): Image Selection from Text to Image.

The user inputs a paragraph of text. The device detects the text input by the user, retrieves a keyword. The keyword may include time, geographic location, object name, contact identity, etc. The device locates an image in the album according to the retrieved time and geographic location, selects a ROI conforming to the keyword according to the object name, contact identity, etc. The device inserts the ROI or the image that the ROI belongs to in the text input by the user.

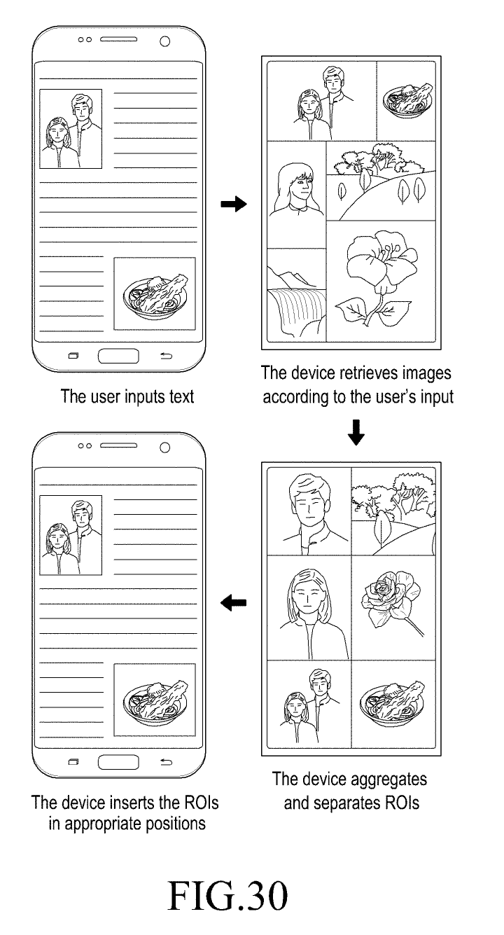

FIG. 30 is a schematic diagram illustrating the image selection from text to image according to various embodiments of the present disclosure.

Referring to FIG. 30, the device retrieves keywords including “today”, “me”, “girlfriend”, “scenery”, “Nanjing”, “lotus”, and “food” from the text input by the user. The device determines images according to the keywords, selects ROIs containing the contents of the keywords, and crops the ROIs from the images inserts the ROIs into the text input by the user.

### Embodiment 15: Image Conversion Based on Image Content

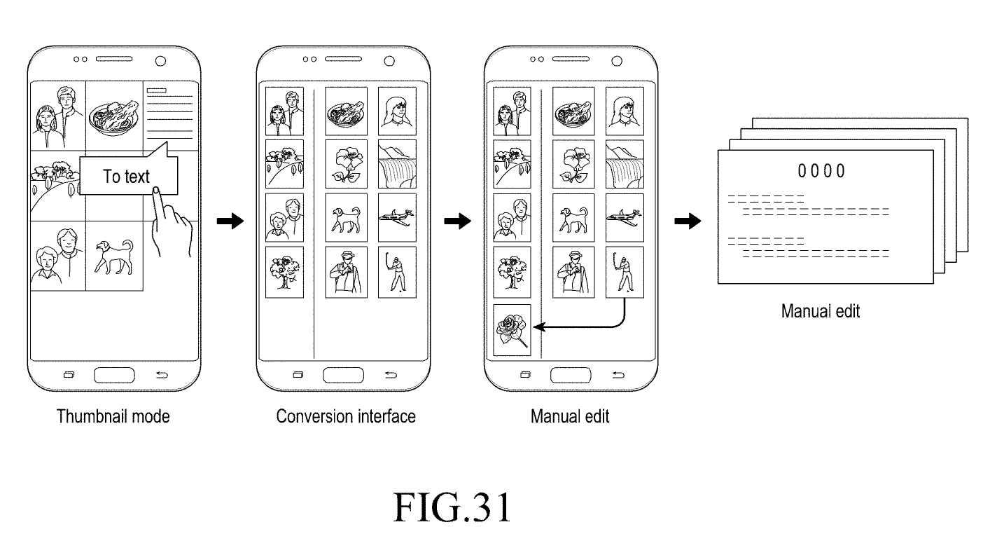

FIG. 31 is a schematic diagram illustrating image conversion based on image content according to various embodiments of the present disclosure.

Operation 1: The Device Detects and Aggregates File Images.

The device detects images with a text label in the device. The device determines whether the images with the text label are from the same file according to appearance style and content of the file. For example, file images with the same PPT template come from the same file. The device analyzes the text in the images according to natural language processing, and determines whether the images are from the same file.

This operation may be triggered to be implemented automatically. For example, the device monitors in real time the change of image files in the album. If monitoring that the number of image files in the album changes, e.g., the number of image files is increased, this operation is triggered to be implemented. For another example, in instant messaging application, the device automatically detects whether an image received by the user is a text image. If yes, this operation is triggered to be implemented, i.e., text images are aggregated in a session of the instant messaging application. The device may detect and aggregate the text images in the interaction information of one contact, or in the interaction information of a group.

Optionally, this operation may be triggered to be implemented manually by the user. For example, a text image combination button may be configured in the menu of the album. When detecting that the user clicks the button, the device triggers the implementation of this operation. For another example, in instant messaging application, when detecting that the user long presses a received image and selects a convert to text option, the device executes this operation.

Operation 2: The Device Prompts the User to Convert the Image into Text.

In the thumbnail mode, the device displays images from the same document in some manners, e.g., via rectangle frames of the same color, and displays a button on them. When the user clicks the button, the device detects that the conversion button is clicked and enters into the image to text conversion mode.

In the instant messaging application, if the device detects that the image received by the user includes text image, the device prompts the user via some manners, e.g., via special colors, popping out a bubble, etc., to inform that the image can be converted into text, and displays a button at the same time. When detecting that the user clicks the button, the device enters the image to text conversion mode.

Operation 3: The Device Generates a File According to the User's Response.

In the image to text conversion mode, the user may manually add or delete an image. The device adds or deletes the image to be converted into text according to the user's operation. When detecting that the user clicks the “convert” button, the device performs text detection and optical character recognition in the image, converts the characters in the image into text, and saves the text as a file for user's subsequent use.

### Embodiment 16: Intelligent Deletion Recommendation Based on Image Content

Operation 1: Determine an Image Similarity Degree Based on ROIs in the Images.

Respective ROIs are cropped from the images containing the ROIs. The ROIs from different images are compared to determine whether the images contain similar contents.

For example, image 1 includes contacts 1, 2 and 3; image 2 includes contacts 1, 2 and 3; image 3 includes contacts 1, 2 and 4. Thus, image 1 and image 2 have a higher similarity degree.

For another example, image 4 includes a ROI containing a red flower. Image 5 includes a ROI containing a red flower. Image 6 includes a ROI containing a yellow flower. Thus, image 4 and image 5 have a higher similarity degree.

In this operation, if the similarity degree of ROIs of two images is proportion to the similarity degree of the images, the position of the ROI is irrelevant to the similarity degree.

Operation 2: Determine Whether the Image has Sematic Information According to the ROI of the Image.

The device retrieves the region field of the ROI of the image. If the image includes a ROI with a category label, the image has semantic information, e.g., the image includes people, car, pet. If the image includes a ROI without category label, the image has less semantic information, e.g. boundary of a geometric figure. If the image does not include any ROI, the image has no semantic information, e.g., a pure color image, an under-exposed image.

Operation 3: Determine an Aesthetic Degree of the Image According to a Position Relationship of the ROIs of the Image.

The device retrieves the category and position coordinates of each ROI from the region list of the image, determines the aesthetic degree of the image according to the category and position coordinates of each ROI. The determination may be performed according to a golden section rule. For example, if each ROI of an image is located on the golden section point, the image has a high aesthetic degree. For another example, if the ROI containing a tree is right above the ROI containing a person, the image has a relatively low aesthetic degree.

It should be noted that, the execution sequence of the operations 1, 2 and 3 may be adjusted. It is also possible to execute two or three of the operations 1, 2 and 3 at the same time. This is not restricted in the present disclosure.

Operation 4: The Device Recommends the User to Perform Deletion.

The device aggregates images with high similarity degrees and recommends the user to delete. The device recommends the user to delete images whose category labels do not contain or contain less semantic information. The device recommends the user to delete images with low aesthetic degree. When recommending the user to delete images with high similarity degree, a first image is taken as a reference. Difference of each image compared with the first image is shown to facilitate the user to select the reserved image.

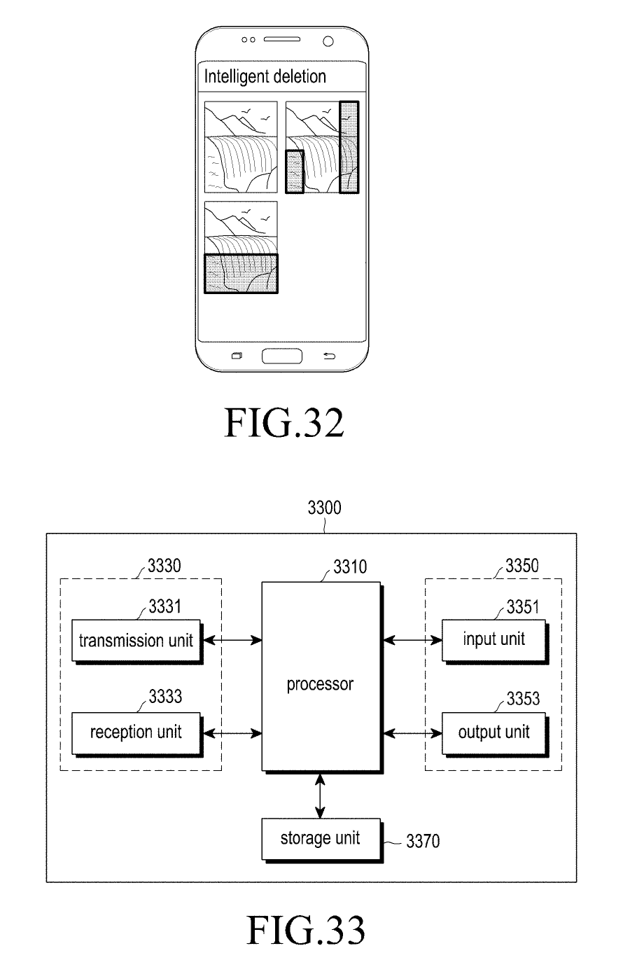

FIG. 32 is a schematic diagram illustrating intelligent deletion based on image content according to various embodiments of the present disclosure.

Referring to FIG. 32, difference between images may be highlighted using color blocks.

Operation 5: The Device Detects the User's Operation and Deletes Image.

The user selects the image needs to be reserved in the images recommended to be deleted, and clicks a delete button after confirmation. After detecting the user's operation, the device reserves the images that the user selects to reserve, and deletes other images. Alternatively, the user selects images to be deleted in the images recommended to be deleted, and clicks a delete button after confirmation. After detecting the user's operation, the device deletes the images selected by the user and reserves other images.

Through this embodiment, unwanted images can be deleted quickly.

In accordance with the above, embodiments of the present disclosure also provide an image management apparatus.

FIG. 33 is a schematic diagram illustrating a structure of the image management apparatus according to various embodiments of the present disclosure.

Referring to FIG. 33, the image management apparatus 3300 includes a processor 3310 (e.g., at least one processor), a transmission/reception unit 3330 (e.g., a transceiver), an input unit 3351 (e.g., an input device), an output unit 3353 (e.g., an output device), and a storage unit 3370 (e.g., a memory). Here, the input unit 3351 and the output unit 3353 may be configured as one unit 3350 according to the type of a device, and may be implemented as a touch display, for example.

First, the processor 3310 controls the overall operation of the image management apparatus 3300, and in particular, controls operations related to image processing operations in the image management apparatus 3300 according to the embodiments of the present disclosure. Since the operations related to image processing operations performed by the image management apparatus 3300 according to the embodiments of the present disclosure are the same as those described with reference to FIGS. 1 to 32, a detailed description thereof will be omitted here.

The transmission/reception unit 3330 includes a transmission unit 3331 (e.g., a transmitter) and a reception unit 3333 (e.g., a receiver). Under the control of the processor 3310, the transmission unit 3331 transmits various signals and various messages to other entities included in the system, for example, other entities such as another image management apparatus, another terminal, and another base station. Here, the various signals and various messages transmitted by the transmission unit 3331 are the same as those described with reference to FIGS. 1, 2A and 2B, 3, 4, 5A to 5D, 6A to 6C, 7 to 11, 12A and 12B, 13A to 13G, 14A to 14C, 15A to 15C, 16 to 20, 21A and 21B, 22 to 25, 26A to 26C, and 27 to 32, and a detailed description thereof will be omitted here. In addition, under the control of the processor 3310, the reception unit 3333 receives various signals and various messages from other entities included in the system, for example, other entities such as another image management apparatus, another terminal, and another base station. Here, the various signals and various messages received by the reception unit 3333 are the same as those described with reference to FIG. 1 to FIG. 32, and thus a detailed description thereof will be omitted.

Under the control of the processor 3310, the storage unit 3370 stores programs and various pieces of data related to image processing operations by an image management apparatus according to an embodiment of the present disclosure. In addition, the storage unit 3370 stores various signals and various messages received, by the reception unit 3333, from other entities.

The input unit 3351 may include a plurality of input keys and function keys for receiving an input of control operations, such as numerals, characters, or sliding operations from a user and setting and controlling functions, and may include one of input means, such as a touch key, a touch pad, a touch screen, or the like, or a combination thereof. In particular, when receiving an input of a command for processing an image from a user according to the embodiments of the present disclosure, the input unit 3351 generates various signals corresponding to the input command and transmits the generated signals to the processor 3310. Here, commands input to the input unit 3351 and various signals generated therefrom are the same as those described with reference to FIG. 1 to FIG. 32, and thus a detailed description thereof will be omitted here.

Under the control of the processor 3310, the output unit 3353 outputs various signals and various messages related to image processing operations in the image management apparatus 3300 according to an embodiment of the present disclosure. Here, the various signals and various messages output by the output unit 3353 are the same as those described with reference to FIG. 1 to FIG. 32, and a detailed description thereof will be omitted here.

Meanwhile, FIG. 33 shows a case in which the image management apparatus 3300 is implemented as a separate unit, such as a processor 3310, a transmission/reception unit 3330, an input unit 3351, an output unit 3353, and a storage unit 3370. The image management apparatus 3300 may be implemented in a form obtained by integrating at least two among the processor 3310, the transmission/reception unit 3330, the input unit 3351, the output unit 3353, and the storage unit 3370. In addition, the image management apparatus 3300 may be implemented by a single processor.

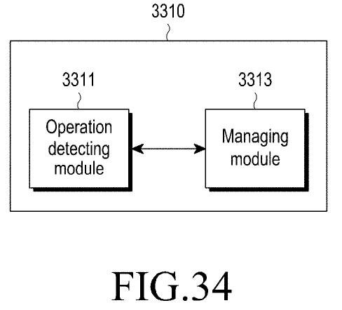

FIG. 34 is a schematic block diagram illustrating a configuration example of a processor included in an image management apparatus according to various embodiments of the present disclosure.

Referring to FIG. 34, in order to control operations related to image processing operations in the image management apparatus 3300, the processor 3310 may include an operation detecting module 3311, to detect an operation of the user with respect to an image; and a managing module 3313, to perform image management based on the operation and a ROI in the image.

In view of the above, embodiments of the present disclosure mainly include: (1) a method for generating a ROI in an image; (2) applications based on the ROI for image managements, such as image browsing and searching, quick sharing, etc.

In particular, the solution provided by embodiments of the present disclosure is able to create a region list for an image, wherein the region list includes a browsing frequency of the image, category of object contained in each region of the image, focusing degree of each region, etc. When browsing images, the user may select multiple ROIs in the image and may have multiple kinds of operations on each ROI, e.g. single tap, double tap, sliding, etc. Different searching results generated via different operations may be provided to the user as candidates. The order of the candidate images may be determined according to the user's preference. In addition, the user may also select multiple ROIs from multiple images for searching, or select a ROI from the image captured by the camera in real time for searching, so as to realize quick browsing. In addition, a personalized tree hierarchy may be created according to distribution of images in the user's album, such that the images may be better organized and the user is facilitated to have a quick browsing.

As to the image transmission and sharing, the solution provided by the embodiments of the present disclosure performs a compression with low compression ratio to the ROI via partial compression to keep rich details of the ROI, and performs a compression with high compression ratio to regions other than the ROI to save power and bandwidth consumption during transmission. Further, through analyzing image contents and establishing associations between images, the user is facilitated to have a quick sharing. For example, in an instant messaging application, the input of the user may be analyzed automatically to crop a relevant region from an image and provide to the user for sharing, etc.

The solution of the present disclosure also realizes image selection, including two manners: from image to text, and from text to image.

Embodiments of the present disclosure also realize conversion of text images from the same source into a file.

Embodiments of the present disclosure further realize intelligent deletion recommendation, so as to recommend images which are visually similar, with similar contents, has low image quality and with no semantic object to the user to delete.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An image management method, the method comprising:
detecting an operation of a user on an image; and
performing image management according to the operation and a region of interest (ROI) of the user in the image.

2. The method of claim 1, further comprising:
selecting at least two ROIs,
wherein the at least two ROIs belong to the same image or different images, and
wherein the performing the image management comprises providing relevant images and/or video frames according to the selecting operation selecting the at least two ROIs.

3. The method of claim 1, further comprising:
selecting the ROI or searching for content input operation,
wherein the searching content input operation comprises a text input operation and/or a voice input operation, and
wherein the performing the image management comprises providing corresponding images and/or video frames according to the selection operation and/or the searching content input operation.

4. The method of claim 2, wherein the providing of the corresponding images and/or video frames according to the selecting or the searching for the content input operation comprises at least one of:
if the selection operation is a first type selection operation, the provided corresponding images and/or video frames comprise a ROI corresponding to all ROIs operated by the first type selection operation,
if the selection operation is a second type selection operation, the provided corresponding images and/or video frames comprise a ROI corresponding to at least one of the ROIs operated by the second type selection operation;
if the selection operation is a third type selection operation, the provided corresponding images and/or video frames do not comprise a ROI corresponding to ROIs operated by the third type selection operation,
if the searching content input operation is a first type searching content input operation, the provided corresponding images and/or video frames comprise a ROI corresponding to all ROIs operated by the first type searching content input operation,
if the searching content input operation is a second type searching content input operation, the provided corresponding images and/or video frames comprise a ROI corresponding to at least one of the ROIs operated by the second type searching content input operation, or
if the searching content input operation is a third type searching content input operation, the provided corresponding images and/or video frames do not comprise a ROI corresponding to the ROIs operated by the third type searching content input operation.

5. The method of claim 2, wherein, after the providing of the corresponding images and/or video frames, the method further comprising:
determining priorities of the corresponding images and/or video frames;
determining a displaying order according to the priorities of the corresponding images and/or video frames; and
displaying the corresponding images and/or video frames according to the displaying order.

6. The method of claim 5, wherein the determining of the priorities of the corresponding images and/or video frames comprises at least one of:
determining the priorities of the corresponding images and/or video frames according to one data item in relevant data collected in a whole image level,
determining the priorities of the corresponding images and/or video frames according to at least two data items in relevant data collected in a whole image level,
determining the priorities of the corresponding images and/or video frames according to one data item in relevant data collected in an object level,
determining the priorities of the corresponding images and/or video frames according to at least two data items in relevant data collected in an object level,
determining the priorities of the corresponding images and/or video frames according to semantic combination of objects, or
determining the priorities of the corresponding images and/or video frames according to relevant positions of objects.

7. The method of claim 2, wherein the selecting of the ROI is detected in at least one of:
a camera preview mode,
an image browsing mode, or a thumbnail browsing mode.

8. The method of claim 1, wherein the performing of the image management comprises at least one of:
determining an image to be shared; sharing the image with a sharing object; or
determining an image to be shared according to a chat object or chat content with a chat object, and sharing the image to be shared with the chat object.

9. The method of claim 1, wherein the performing of the image management comprises at least one of:
determining a contact group to which the image is to be shared according to the ROI of the image, sharing the image to the contact group according to a group sharing operation of the user,
determining contacts with which the image is to be shared according to the ROI of the image, respectively transmitting the image to each of the contacts according to an individual sharing operation of the user, wherein the image shared with each contact comprises a ROI corresponding to the contact,
when a chat sentence between the user and a chat object is corresponding to the ROI of the image, recommending the image to the user as a sharing candidate, or
when the chat object is corresponding to the ROI of the image, recommending the image to the user as a sharing candidate.

10. The method of claim 8, further comprising:
after the sharing of the image, identifying the shared image according to contacts with which the image is shared.

11. The method of claim 1, wherein the performing of the image management comprises at least one of:
if a displaying screen is smaller than a predefined size, displaying a category image or a category name of the ROI, and switching to display another category image or category name of the ROI based on a switching operation of the user,
if the displaying screen is smaller than the predefined size and a category of the ROI is selected based on a selection operation of the user, displaying images of the category, and switching to display other images in the category based on a switching operation of the user, or
if the displaying screen is smaller than the predefined size, displaying the image based on a number of ROIs.

12. The method of claim 11, wherein, if the displaying screen is smaller than the predefined size, the displaying of the image based on the number of ROIs comprises:
if the image does not contain ROI, displaying the image in a thumbnail mode or displaying the image after reducing the size of the image to be appropriate to the displaying screen,
if the image contains one ROI, displaying the ROI, and
if the image contains multiple ROIs, alternately displaying the ROIs in the image; or displaying a first ROI in the image, and switching to display another ROI based on a switching operation of the user.

13. The method of claim 1, further comprising:
image transmission between a plurality of device,
wherein, during the image transmission between the plurality of devices, the performing of the image management comprises at least one of:
based on an image transmission parameter and the ROI in the image, compressing the image and transmitting the compressed image; or
receiving an image from a server, a base station or a user device, wherein the image is compressed based on an image transmission parameter and the ROI.

14. The method of claim 13, wherein the compressing of the image comprises at least one of:
if the image transmission parameter meets a ROI non-compression condition, compressing image regions except for the ROI in the image to be transmitted, and not compressing the ROI in the image to be transmitted,
if the image transmission parameter meets a differentiated compression condition, compressing the image regions except for the ROI in the image to be transmitted with a first compression ratio, and compressing the ROI in the image to be transmitted with a second compression ratio, wherein the second compression ratio is lower than the first compression ratio,
if the image transmission parameter meets an undifferentiated compression condition, compressing the image regions except for the ROI in the image to be transmitted as well as the ROI in the image to be transmitted with the same compression ratio,
if the image transmission parameter meets a non-compression condition, not compressing the image to be transmitted, or
if the image transmission parameter meets a multiple compression condition, performing a compressing processing and one or more times of transmission processing to the image to be transmitted.

15. The method of claim 14,
wherein the image transmission parameter comprises at least one of a quality of the image to be transmitted, a transmission network type, or a transmission network quality, and
wherein the method further comprises at least one of:
if the number of images to be transmitted is lower than a first threshold, determining that the image transmission parameter meets the non-compression condition,
if the number of images to be transmitted is higher than or equal to the first threshold but lower than a second threshold, determining that the image transmission parameter meets the ROI compression condition, wherein the second threshold is larger than the first threshold,
if the number of images to be transmitted is higher than or equal to the second threshold, determining that the image transmission parameter meets the ROI undifferentiated compression condition,
if an evaluated value of the transmission network quality is lower than a predefined third threshold, determining that the image transmission parameter meets the multiple compression condition,
if the evaluated value of the transmission network quality is higher than or equal to the third threshold but lower than a predefined fourth threshold, determining that the image transmission parameter meets the differentiated compression condition, wherein the fourth threshold is larger than the third threshold, or
if the transmission network type is a free network, determining that the image transmission parameter meets the non-compression condition.

16. The method of claim 1, wherein the performing of the image management comprises:
selecting images based on the ROI, and
generating an image tapestry based on the selected images, wherein a ROI of each selected image is displayed in the image tapestry.

17. The method of claim 16, further comprising:
detecting a selection operation of the user selecting the ROI in the image tapestry; and
displaying a selected image containing the ROI selected by the user.

18. The method of claim 1, wherein the performing of the image management comprises:
detecting text input by the user,
searching for an image containing a ROI associated with the text, and
inserting the image containing the ROI into the text input by the user.

19. The method of claim 1, further comprising:
when determining that multiple images are from a same file, automatically aggregating the multiple images into a file, or aggregating the multiple images into a file based on a trigger operation of the user.

20. The method of claim 1, wherein the performing of the image management comprises at least one of:
based on a comparing result of categories of ROIs in different images, automatically deleting or recommending deleting an image,
determining semantic information containing degrees of different images based on the ROIs of the images, automatically deleting or recommending deleting an image based on a comparing result of the semantic information containing degree of different images,
determining scores of different images according to relative positions of ROIs in the different images, and automatically deleting or recommending deleting an image based on the scores, or
determining scores of different images according to an absolute position of at least one ROI in the different images, and automatically deleting or recommending deleting an image based on the scores.

21. The method of claim 1, wherein the performing of the image management comprises at least one of:
determining a personalized category of the image or the ROI,
adjusting a predefined classification model, to enable the classification model to classify images according to the personalized category, or
performing a personalized classification to images or ROIs utilizing the adjusted classification model.

22. The method of claim 21, wherein the adjusting of the predefined classification model comprises:
if predefined categories of the classification model in the device comprise the personalized category, re-combining the predefined categories in the classification model in the device to obtain the personalized category,
if predefined categories of the classification model in the device do not comprise the personalized category, adding the personalized category in the classification model in the device,
if predefined categories in the classification model in a cloud end comprise the personalized category, re-combining predefined categories in the classification model in the cloud end to obtain the personalized category, and
if predefined categories in the classification model in the cloud end do not comprise the personalized category, adding the personalized category in the classification model in the cloud end.

23. The method of claim 21, wherein, after the performing of the personalized classification to the images or the ROIs, the method further comprises at least one of:
receiving, by the device, classification error feedback information provided by the user, training the adjusted classification model in the device according to the classification error feedback information;
receiving, by a cloud end, classification error feedback information provided by the user, and training the adjusted classification model according to the classification error feedback information; or
if a personalized classification result of the cloud end is inconsistent with that of the device,
updating the personalized classification result of the device according to the personalized classification result of the cloud end, and
transmitting classification error feedback information to the cloud end.

24. The method of claim 1, wherein the ROI comprises at least one of:
an image region corresponding to a manual focus point,
an image region corresponding to an auto-focus point,
an object region,
a hot region in a gaze heat map, or
a hot region in a saliency map.

25. The method of claim 1, further comprising:
categorizing a plurality of images according to the detecting of the operation of the user and the performing of the image management according to a user's preference; and
selective browsing the plurality of images according to the user's preference.

26. The method of claim 1, further comprising at least one of:
generating a category label according to an object region detecting result, or
inputting the ROI into an object classifier, and generating a category label according to an output of the object classifier.

27. An image management apparatus, the apparatus comprising:
a memory; and
at least one processor configured to:
detect an operation of a user on an image, and
perform image management according to the operation and a region of interest (ROI) in the image.
